SEQUENCE LISTING (23 sequences)

SEQ ID NO: 1 - DNA, 12 bp, Homo sapiens
agggatagaagg

SEQ ID NO: 2 - DNA, 12 bp, Homo sapiens
aggtatagaagg

SEQ ID NO: 3 - DNA, 27 bp, Homo sapiens
cttctgtccaggggcgatgagggcatt

SEQ ID NO: 4 - protein, 9 aa, Homo sapiens
KQGPAILAN

SEQ ID NO: 5 - DNA, 124 bp, Homo sapiens
ataaagtcgttcacagaagagagaaataacatgaggttcatttacgtcttttgtgcatctataggagaaggagaaggaagagttggtattatcctgactttagccatgaatatcatgagtacat

SEQ ID NO: 6 - protein, 19 aa, Homo sapiens
EGEGRVGIILTLAMNIMST

SEQ ID NO: 7 - DNA, 15 bp, Homo sapiens
catctattggagaag

SEQ ID NO: 8 - DNA, 123 bp, Homo sapiens
ctaattgtgaaattgtctgccattcttaaaaacaaaaatgttgttatttttatttcagatgcgatctgtgagccgagtctttaagttcattgacatgccaacagaaggtaaacctaccaagtc

SEQ ID NO: 9 - protein, 21 aa, Homo sapiens
MRSVSRVFKFIDMPTEGKPTK

SEQ ID NO: 10 - DNA, 15 bp, Homo sapiens
tcagatgtgatctgt

SEQ ID NO: 11 - DNA, 17 bp, Homo sapiens
ctacatatctgacaggt

SEQ ID NO: 12 - protein, 5 aa, Homo sapiens
TYLTG

SEQ ID NO: 13 - DNA, 56 bp, Homo sapiens
ggatgggcctggtgctggcgctggcgctggcgctggcgctggcgctggctctgtct

SEQ ID NO: 14 - protein, 18 aa, Homo sapiens
MGLVLALALALALALALS

SEQ ID NO: 15 - DNA, 21 bp, Homo sapiens
ggatgggcctggtgctggcgc

SEQ ID NO: 16 - protein, 6 aa, Homo sapiens
MGLVLA

SEQ ID NO: 17 - DNA, 22 bp, Homo sapiens
gagaatgatgatgaagtacagg

SEQ ID NO: 18 - DNA, 10 bp, Homo sapiens
agttgttaca

SEQ ID NO: 19 - DNA, 11 bp, Homo sapiens
aatttggtgct

SEQ ID NO: 20 - DNA, 21 bp, Homo sapiens
tatgtattaccgaaaaagcct

SEQ ID NO: 21 - DNA, 21 bp, Homo sapiens
tatgtattactgaaaaagcct

SEQ ID NO: 22 - DNA, 99 bp, Homo sapiens
aggtttagcatgagctttaacagacataatctgaaatactatgtattaccgaaaaagcctaaaaaggtggcatttgattgcctagaatggatcagaaag

SEQ ID NO: 23 - protein, 32 aa, Homo sapiens
FSMSFNRHNLKYYVLPKKPKKVAFDCLEWIRK

(19) United States
(12) Patent Application Publication
(10) Pub. No.: US 2014/0129201 A1
(43) Pub. Date: May 8, 2014

(54) VALIDATION OF GENETIC TESTS

(71) Applicant: Good Start Genetics, Inc., Cambridge, MA (US)

(72) Inventors: Caleb Kennedy, Arlington, MA (US); Gregory Porreca, Cambridge, MA (US); Mark Umbarger, Brookline, MA (US)

(73) Assignee: GOOD START GENETICS, INC., Cambridge, MA (US)

(21) Appl. No.: 14/043,113

(22) Filed: Oct. 1, 2013

Related U.S. Application Data
(60) Provisional application No. 61/723,508, filed on Nov. 7, 2012.

(51) Int. Cl. G06F 19/18

(52) U.S. Cl. CPC G06F 19/18
USPC 703/11

(57) ABSTRACT

The invention provides a method for validating a genetic test by introducing a simulated mutation into sequence reads. By editing the information in one or more sequence read files, a set of sequence reads can be manipulated to represent an expected genotype. An analysis of those sequence reads produces an observed genotype and concordance between the expected and observed genotypes validates the analysis. Thus, the invention provides methods for validating new genetic tests.

### CROSS-REFERENCE TO RELATED APPLICATION

This application claims the benefit of, and priority to, U.S. Provisional Patent Application No. 61/723,508, filed Nov. 7, 2012, the contents of which are incorporated by reference.

### SEQUENCE LISTING

This application contains a sequence listing which has been submitted in ASCII format via EFS-Web and is hereby incorporated by reference in its entirety. The ASCII-formatted sequence listing, created on Sep. 30, 2013, is named GSGE-014-01US-Sequence-listing_ST25, and is 4,441 bytes in size.

### FIELD OF THE INVENTION

The invention generally relates to genetic testing and more particularly to methods of validating a genetic test.

### BACKGROUND

Genetic testing gives people valuable information. For example, carrier screening can determine if members of a couple are both carriers of a recessive genetic disorder. With this information, the couple can learn or rule out that they are at risk for having children with the genetic disorder. As new technologies such as next-generation sequencing (NGS) emerge, those technologies promise to provide more rapid and affordable genetic tests.

Next-generation sequencing instruments have the capability to sequence millions of DNA characters per second in a single instrument. High-powered computer systems are used to analyze the resulting data. Typically, a new sequencing technology or a new sequence analysis method will only be used clinically once it is shown to be sensitive and reliable for genetic screening. However, some mutations by their very nature are problematic to detect.

For instance, the medical literature contains information on some clinically-significant mutations that are rare enough that biological samples containing those mutations are not readily available. In cases like these, it is a challenge to establish if a new sequencing technology will be sensitive enough to reliably detect such rare mutations.

Another problem is that some combinations of mutations, while important to identify, are difficult to detect. As an example, some NGS platforms have difficulty correctly genotyping a substitution very close to a deletion. Nevertheless, in some contexts, a substitution close to a deletion is indicative of a genetic disorder and is clinically important to detect.

It is problematic if a genetic test is known to give false negatives. However, it can be a bigger problem where it is not known how a genetic test performs. With no way of knowing the sensitivity and reliability of a genetic test, the medical profession will not adopt that test. As a consequence, the potential power of such tests will not be realized.

### SUMMARY

The invention provides a method for validating a genetic test by introducing a simulated mutation into the sequence reads produced by a sequencer and analyzing those reads. By editing the information in the sequence reads, those sequence reads can be manipulated to represent a known genotype. In this fashion, a mutation from the literature or a hard-to-detect combination of mutations can be provided into a genetic analysis, giving the analysis an expected result that can be compared to an observed result, thereby revealing if the analysis is accurate. Further, it is realized that the genetic context of some mutations affects the genetic analysis. For example, a deletion at the end of a sequence read can interfere with the successful sequence read assembly. Simulating such a mutation in the sequence reads preserves information about the genetic context of the mutation. This can reveal that the genetic context is interfering with the ability of a genetic test to detect the mutation. Methods of the invention are scalable and can be used to rapidly simulate large numbers of mutations and combinations of mutations. By using a computer to manipulate the sequence reads, genetic tests can be evaluated at a pace and volume commensurate with NGS sequencer output. Validation of genetic tests can be performed concurrently with sequencing or after-the-fact, with previously-generated data sets. By validating the sensitivity and reliability of new genetic tests, those tests can be shown to be suitable for clinical use. Accordingly, the potential power of NGS and computational analysis can be brought to bear in genetic testing.

In certain aspects, the invention provides a method of evaluating a genetic test. The method involves obtaining a plurality of sequence reads, introducing a simulated mutation into at least one of the plurality of sequence reads, and analyzing the sequence reads to determine if the test identifies the simulated mutation. To mimic the expected genotype of a heterozygous carrier, the simulated mutation can be introduced into each of those sequence reads that span a location of the mutation with a probability of 0.5 (e.g., into about half of those sequence reads that should contain the location of the simulated mutation). The simulated mutation can be introduced by manipulating a data field in the sequence read such as, for example, a base sequence field or quality data field. The sequences can be manipulated by a computer program. For example, a program can be written using Java, Groovy, Python, Perl, or other languages, or a combination thereof, that can automatically insert simulated mutations into sequence reads. Computer-based methods can be used to automatically introduce a number of different simulated mutations into different ones of the plurality of sequence reads.

The sequence reads including the manipulated reads are analyzed to detect a genotype. Analysis can include any method known in the art, such as de novo assembly, alignment to a reference, or a combination thereof. In some embodiments, the sequence reads are assembled into a contig. The contig can be aligned to a reference genome. In certain embodiments, individual reads are then aligned back to the contig.

In a related aspect, the invention provides a method for validating a genetic test by obtaining a plurality of sequence reads, introducing a simulated mutation associated with an expected genotype into at least one of the reads, and analyzing the reads to determine a genotype. The observed (determined) and expected genotype are compared. A match between the observed and expected genotypes shows the validity of the analysis.

In some aspects, the invention provides a computer-based system for genetic testing. The system includes a processor coupled to a tangible, non-transitory memory that contains instructions operable to facilitate validation of genetic tests. The system may be operated to receive a plurality of sequence reads, introduce a simulated mutation into at least one of the sequence reads, and analyze the plurality of sequence reads to determine a genotype. In certain embodiments, the system introduces the simulated mutation into each read that would contain the mutation with a probability of 0.5 (e.g., into about half of those sequence reads that cover a location of the mutation on a genome). The computer-based system can manipulating one or more data fields for base sequence or quality in the sequence reads. In certain embodiments, the system operates to receive information about a genomic position of the simulated mutation, identify an individual read associated with the genomic position from the plurality of sequence reads, and introduce the simulated mutation into the individual read. In some embodiments, the system operates to identify a subset of reads associated with the genomic position from the plurality of sequence reads and introduce the simulated mutation into each read of the subset of reads with a probability of about 0.5.

### BRIEF DESCRIPTION OF THE DRAWINGS

FIG. 1 is a diagram of methods of validating a genetic test.

FIG. 2 represents Sanger results for heterozygous sample.

FIG. 3 represents Sanger results for homozygous sample.

FIG. 4 represents NGS results for heterozygous sample.

FIG. 5 represents NGS results for homozygous sample.

FIG. 6 shows a computer system to evaluate the validity of genetic tests.

FIG. 7 diagrams the validation of a genotyping by a method of the invention.

FIG. 8 illustrates obtaining sequence reads and inserting a simulated mutation.

FIG. 9 shows an example in which a standard analytical method is performed for comparison to a GATA-based method.

FIG. 10 shows analysis of sequence reads that include simulated mutations by GATA.

FIG. 11 gives an view of NGS data for a genotype call of interest as shown by the Integrative Genomics Viewer (IGV).

FIG. 12 shows bi-directional Sanger data for the variant-containing region.

FIG. 13 provides a histogram of allele ratios for non-reference genotype calls in chromosome 11 derived from whole-genome shotgun sequencing (WGSS) of a sample.

FIG. 14 shows genome-wide relative coverage for GM18540.

FIG. 15 shows an IGV view of a heterozygous splice site mutation.

FIG. 16 shows Sanger chromatograms confirming existence of a mutation.

FIG. 17 shows a sample heterozygous for premature stop codon mutation.

FIG. 18 depicts Sanger results confirming existence of mutation.

FIG. 19 represents results from a heterozygous sample.

FIG. 20 represents a heterozygous deletion in sample.

FIG. 21 depicts a heterozygous 12 bp insertion and homozygous substitution.

FIG. 22 shows compound heterozygous 6 and 12 bp deletions in sample.

FIG. 23 shows dropout of reference allele leads to homozygous non-reference call by Sanger sequencing with unmodified primer pair in BLM exon 12.

FIG. 24 shows Sanger results using a re-designed primer pair in BLM exon 12.

FIG. 25 shows heterozygous non-reference call by IGV of NGS data in BLM exon 12.

FIG. 26 shows homozygous reference call using an unmodified primer pair and Sanger sequencing for a dropout in DLD exon 9.

FIG. 27 shows Sanger results for a re-designed primers for the dropout in DLD exon 9.

FIG. 28 shows heterozygous reference call NGS data for the dropout in DLD exon 9.

### DETAILED DESCRIPTION

For a genetic analysis method such as an NGS platform to be used for clinical genetic testing, it must satisfy at least three requirements. First, analytical accuracy must be both high and well characterized within the clinically relevant genes or regions. Second, sequencing technologies should yield data sufficient to cover the vast majority of targeted bases at a depth sufficient to make high-quality genotype calls while computational technologies should have power commensurate with the yield of sequencing technologies. Finally, workflow should be robust and reproducible, which can often be achieved through automation.

One insight of the invention is that different analytical methodologies offer different accuracy and further that one analytical method can offer different accuracies in different contexts. Moreover, a relationship between genetic context and accuracy of analytical methods cannot be fully understood without methods for evaluating a genetic analysis. Thus, the invention provides methods for evaluating a genetic analysis. Any type of genetic analysis can be evaluated using methods of the invention. For example, the ability of primers and probes to detect and amplify certain targets can be evaluated. Methods of the invention can be used to test the validity of sequencing or other molecular tests.

In some embodiments, a clinic or lab will use one or more analytical pipelines to study genetic material. Analytical pipelines may include sample collection, sample prep, laboratory analysis, and computational analysis. Any new or existing analytical pipeline may be evaluated using methods of the invention. For example, in some embodiments, a clinic or lab may use methods described herein to validate the sensitivity and accuracy of their existing analytical pipelines, to validate prospective new analytical pipelines before they are introduced, or both.

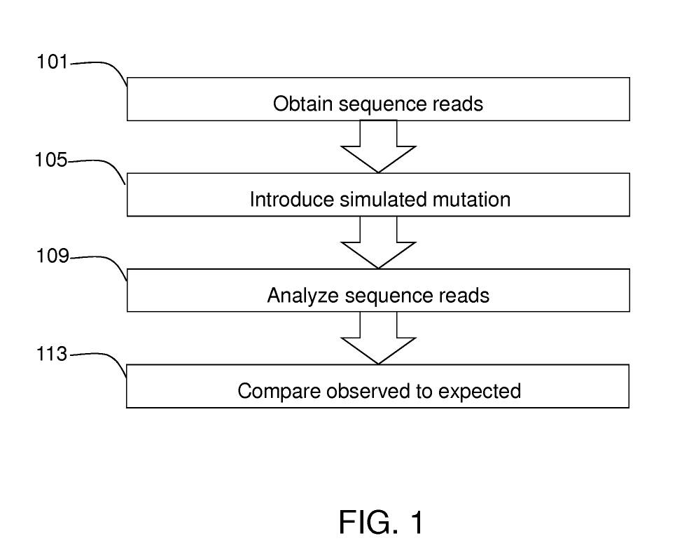

FIG. 1 is a diagram of methods of validating a genetic test. In general, methods of the invention include obtaining 101 sequence reads and introducing 105 a simulated mutation into at least one of the reads. Sequence reads may be obtained 101 by any method including loading into computer memory files from prior work or receiving computer files from an outside source. In certain embodiments, the sequence reads are obtained 101 by isolating nucleic acid from a sample and sequencing the nucleic acid.

Nucleic acid template molecules (e.g., DNA or RNA) can be isolated from a sample containing other components, such as proteins, lipids and non-template nucleic acids. Nucleic acid can be obtained directly from a patient or from a sample such as blood, urine, cerebrospinal fluid, seminal fluid, saliva, sputum, stool and tissue. Any tissue or body fluid specimen may be used as a source for nucleic acid. Nucleic acid can also be isolated from cultured cells, such as a primary cell culture or a cell line. Generally, nucleic acid can be extracted, isolated, amplified, or analyzed by a variety of techniques such as those described by Green and Sambrook, Molecular Cloning: A Laboratory Manual (Fourth Edition), Cold Spring Harbor Laboratory Press, Woodbury, N.Y. 2,028 pages (2012); or as described in U.S. Pat. No. 7,957,913; U.S. Pat. No. 7,776,616; U.S. Pat. No. 5,234,809; U.S. Pub. 2010/0285578; and U.S. Pub. 2002/0190663.

Nucleic acid obtained from biological samples may be fragmented to produce suitable fragments for analysis. Template nucleic acids may be fragmented or sheared to desired length, using a variety of mechanical, chemical and/or enzymatic methods. Nucleic acid may be sheared by sonication, brief exposure to a DNase/RNase, hydroshear instrument, one or more restriction enzymes, transposase or nicking enzyme, exposure to heat plus magnesium, or by shearing.

A biological sample may be lysed, homogenized, or fractionated in the presence of a detergent or surfactant as needed. Suitable detergents may include an ionic detergent (e.g., sodium dodecyl sulfate or N-lauroylsarcosine) or a nonionic detergent (such as the polysorbate 80 sold under the trademark TWEEN by Uniqema Americas (Paterson, N.J.) or C₁₄H₂₂O(C₂H₄)ₙ, known as TRITON X-100). Once a nucleic acid is extracted or isolated from the sample it may be amplified.

Amplification refers to production of additional copies of a nucleic acid sequence and is generally carried out using polymerase chain reaction (PCR) or other technologies known in the art. The amplification reaction may be any amplification reaction known in the art that amplifies nucleic acid molecules such as PCR. Other amplification reactions include nested PCR, PCR-single strand conformation polymorphism, ligase chain reaction, strand displacement amplification and restriction fragments length polymorphism, transcription based amplification system, rolling circle amplification, and hyper-branched rolling circle amplification, quantitative PCR, quantitative fluorescent PCR (QF-PCR), multiplex fluorescent PCR (MF-PCR), real time PCR (RTPCR), restriction fragment length polymorphism PCR (PCR-RFLP), in situ rolling circle amplification (RCA), bridge PCR, picotiter PCR, emulsion PCR, transcription amplification, self-sustained sequence replication, consensus sequence primed PCR, arbitrarily primed PCR, degenerate oligonucleotide-primed PCR, and nucleic acid based sequence amplification (NABSA). Amplification methods that can be used include those described in U.S. Pat. Nos. 5,242,794; 5,494,810; 4,988,617; and 6,582,938. In certain embodiments, the amplification reaction is PCR as described, for example, U.S. Pat. No. 4,683,195; and U.S. Pat. No. 4,683,202, hereby incorporated by reference. Primers for PCR, sequencing, and other methods can be prepared by cloning, direct chemical synthesis, and other methods known in the art. Primers can also be obtained from commercial sources such as Eurofins MWG Operon (Huntsville, Ala.) or Life Technologies (Carlsbad, Calif.).

With these methods, a single copy of a specific target nucleic acid may be amplified to a level that can be sequenced. Further, the amplified segments created by an amplification process such as PCR may be, themselves, efficient templates for subsequent PCR amplifications.

Amplification or sequencing adapters or barcodes, or a combination thereof, may be attached to the fragmented nucleic acid. Such molecules may be commercially obtained, such as from Integrated DNA Technologies (Coralville, Iowa). In certain embodiments, such sequences are attached to the template nucleic acid molecule with an enzyme such as a ligase. Suitable ligases include T4 DNA ligase and T4 RNA ligase, available commercially from New England Biolabs (Ipswich, Mass.). The ligation may be blunt ended or via use of complementary overhanging ends. In certain embodiments, following fragmentation, the ends of the fragments may be repaired, trimmed (e.g. using an exonuclease), or filled (e.g., using a polymerase and dNTPs) to form blunt ends. In some embodiments, end repair is performed to generate blunt end 5′phosphorylated nucleic acid ends using commercial kits, such as those available from Epicentre Biotechnologies (Madison, Wis.). Upon generating blunt ends, the ends may be treated with a polymerase and dATP to form a template independent addition to the 3′-end and the 5′-end of the fragments, thus producing a single A overhanging. This single A can guide ligation of fragments with a single T overhanging from the 5′-end in a method referred to as T-A cloning. Alternatively, because the possible combination of overhangs left by the restriction enzymes are known after a restriction digestion, the ends may be left as-is, i.e., ragged ends. In certain embodiments double stranded oligonucleotides with complementary overhanging ends are used.

In certain embodiments, one or more bar code is attached to each, any, or all of the fragments. A bar code sequence generally includes certain features that make the sequence useful in sequencing reactions. The bar code sequences are designed such that each sequence is correlated to a particular portion of nucleic acid, allowing sequence reads to be correlated back to the portion from which they came. Methods of designing sets of bar code sequences is shown for example in U.S. Pat. No. 6,235,475, the contents of which are incorporated by reference herein in their entirety. In certain embodiments, the bar code sequences range from about 5 nucleotides to about 15 nucleotides. In a particular embodiment, the bar code sequences range from about 4 nucleotides to about 7 nucleotides. In certain embodiments, the bar code sequences are attached to the template nucleic acid molecule, e.g., with an enzyme. The enzyme may be a ligase or a polymerase, as discussed above. Attaching bar code sequences to nucleic acid templates is shown in U.S. Pub. 2008/0081330 and U.S. Pub. 2011/0301042, the content of each of which is incorporated by reference herein in its entirety. Methods for designing sets of bar code sequences and other methods for attaching bar code sequences are shown in U.S. Pat. Nos. 6,138,077; 6,352,828; 5,636,400; 6,172,214; 6,235,475; 7,393,665; 7,544,473; 5,846,719; 5,695,934; 5,604,097; 6,150,516; RE39,793; 7,537,897; 6,172,218; and 5,863,722, the content of each of which is incorporated by reference herein in its entirety. After any processing steps (e.g., obtaining, isolating, fragmenting, amplification, or barcoding), nucleic acid can be sequenced.

Sequencing may be by any method known in the art. DNA sequencing techniques include classic dideoxy sequencing reactions (Sanger method) using labeled terminators or primers and gel separation in slab or capillary, sequencing by synthesis using reversibly terminated labeled nucleotides, pyrosequencing, 454 sequencing, Illumina/Solexa sequencing, allele specific hybridization to a library of labeled oligonucleotide probes, sequencing by synthesis using allele specific hybridization to a library of labeled clones that is followed by ligation, real time monitoring of the incorporation of labeled nucleotides during a polymerization step, polony sequencing, and SOLiD sequencing. Separated molecules may be sequenced by sequential or single extension reactions using polymerases or ligases as well as by single or sequential differential hybridizations with libraries of probes.

A sequencing technique that can be used includes, for example, use of sequencing-by-synthesis systems sold under the trademarks GS JUNIOR, GS FLX+ and 454 SEQUENCING by 454 Life Sciences, a Roche company (Branford, Conn.), and described by Margulies, M. et al., Genome sequencing in micro-fabricated high-density picotiter reactors, Nature, 437:376-380 (2005); U.S. Pat. No. 5,583,024; U.S. Pat. No. 5,674,713; and U.S. Pat. No. 5,700,673, the contents of which are incorporated by reference herein in their entirety. 454 sequencing involves two steps. In the first step of those systems, DNA is sheared into fragments of approximately 300-800 base pairs, and the fragments are blunt ended. Oligonucleotide adaptors are then ligated to the ends of the fragments. The adaptors serve as primers for amplification and sequencing of the fragments. The fragments can be attached to DNA capture beads, e.g., streptavidin-coated beads using, e.g., Adaptor B, which contains 5′-biotin tag. The fragments attached to the beads are PCR amplified within droplets of an oil-water emulsion. The result is multiple copies of clonally amplified DNA fragments on each bead. In the second step, the beads are captured in wells (pico-liter sized). Pyrosequencing is performed on each DNA fragment in parallel. Addition of one or more nucleotides generates a light signal that is recorded by a CCD camera in a sequencing instrument. The signal strength is proportional to the number of nucleotides incorporated. Pyrosequencing makes use of pyrophosphate (PPi) which is released upon nucleotide addition. PPi is converted to ATP by ATP sulfurylase in the presence of adenosine 5′ phosphosulfate. Luciferase uses ATP to convert luciferin to oxyluciferin, and this reaction generates light that is detected and analyzed.

Another example of a DNA sequencing technique that can be used is SOLiD technology by Applied Biosystems from Life Technologies Corporation (Carlsbad, Calif.). In SOLiD sequencing, genomic DNA is sheared into fragments, and adaptors are attached to the 5′ and 3′ ends of the fragments to generate a fragment library. Alternatively, internal adaptors can be introduced by ligating adaptors to the 5′ and 3′ ends of the fragments, circularizing the fragments, digesting the circularized fragment to generate an internal adaptor, and attaching adaptors to the 5′ and 3′ ends of the resulting fragments to generate a mate-paired library. Next, clonal bead populations are prepared in microreactors containing beads, primers, template, and PCR components. Following PCR, the templates are denatured and beads are enriched to separate the beads with extended templates. Templates on the selected beads are subjected to a 3′ modification that permits bonding to a glass slide. The sequence can be determined by sequential hybridization and ligation of partially random oligonucleotides with a central determined base (or pair of bases) that is identified by a specific fluorophore. After a color is recorded, the ligated oligonucleotide is removed and the process is then repeated.

Another example of a DNA sequencing technique that can be used is ion semiconductor sequencing using, for example, a system sold under the trademark ION TORRENT by Ion Torrent by Life Technologies (South San Francisco, Calif.). Ion semiconductor sequencing is described, for example, in Rothberg, et al., An integrated semiconductor device enabling non-optical genome sequencing, Nature 475:348-352 (2011); U.S. Pub. 2010/0304982; U.S. Pub. 2010/0301398; U.S. Pub. 2010/0300895; U.S. Pub. 2010/0300559; and U.S. Pub. 2009/0026082, the contents of each of which are incorporated by reference in their entirety.

Another example of a sequencing technology that can be used is Illumina sequencing. Illumina sequencing is based on the amplification of DNA on a solid surface using fold-back PCR and anchored primers. Genomic DNA is fragmented, and adapters are added to the 5′ and 3′ ends of the fragments. DNA fragments that are attached to the surface of flow cell channels are extended and bridge amplified. The fragments become double stranded, and the double stranded molecules are denatured. Multiple cycles of the solid-phase amplification followed by denaturation can create several million clusters of approximately 1,000 copies of single-stranded DNA molecules of the same template in each channel of the flow cell. Primers, DNA polymerase and four fluorophore-labeled, reversibly terminating nucleotides are used to perform sequential sequencing. After nucleotide incorporation, a laser is used to excite the fluorophores, and an image is captured and the identity of the first base is recorded. The 3′ terminators and fluorophores from each incorporated base are removed and the incorporation, detection and identification steps are repeated. Sequencing according to this technology is described in U.S. Pat. No. 7,960,120; U.S. Pat. No. 7,835,871; U.S. Pat. No. 7,232,656; U.S. Pat. No. 7,598,035; U.S. Pat. No. 6,911,345; U.S. Pat. No. 6,833,246; U.S. Pat. No. 6,828,100; U.S. Pat. No. 6,306,597; U.S. Pat. No. 6,210,891; U.S. Pub. 2011/0009278; U.S. Pub. 2007/0114362; U.S. Pub. 2006/0292611; and U.S. Pub. 2006/0024681, each of which are incorporated by reference in their entirety.

Another example of a sequencing technology that can be used includes the single molecule, real-time (SMRT) technology of Pacific Biosciences (Menlo Park, Calif.). In SMRT, each of the four DNA bases is attached to one of four different fluorescent dyes. These dyes are phospholinked. A single DNA polymerase is immobilized with a single molecule of template single stranded DNA at the bottom of a zero-mode waveguide (ZMW). It takes several milliseconds to incorporate a nucleotide into a growing strand. During this time, the fluorescent label is excited and produces a fluorescent signal, and the fluorescent tag is cleaved off. Detection of the corresponding fluorescence of the dye indicates which base was incorporated. The process is repeated.

Another example of a sequencing technique that can be used is nanopore sequencing (Soni, G. V., and Meller, A., Clin Chem 53: 1996-2001 (2007)). A nanopore is a small hole, of the order of 1 nanometer in diameter. Immersion of a nanopore in a conducting fluid and application of a potential across it results in a slight electrical current due to conduction of ions through the nanopore. The amount of current which flows is sensitive to the size of the nanopore. As a DNA molecule passes through a nanopore, each nucleotide on the DNA molecule obstructs the nanopore to a different degree. Thus, the change in the current passing through the nanopore as the DNA molecule passes through the nanopore represents a reading of the DNA sequence.

Another example of a sequencing technique that can be used involves using a chemical-sensitive field effect transistor (chemFET) array to sequence DNA (for example, as described in U.S. Pub. 2009/0026082). In one example of the technique, DNA molecules can be placed into reaction chambers, and the template molecules can be hybridized to a sequencing primer bound to a polymerase. Incorporation of one or more triphosphates into a new nucleic acid strand at the 3′ end of the sequencing primer can be detected by a change in current by a chemFET. An array can have multiple chemFET sensors. In another example, single nucleic acids can be attached to beads, and the nucleic acids can be amplified on the bead, and the individual beads can be transferred to individual reaction chambers on a chemFET array, with each chamber having a chemFET sensor, and the nucleic acids can be sequenced.

Another example of a sequencing technique that can be used involves using an electron microscope as described, for example, by Moudrianakis, E. N. and Beer M., in Base sequence determination in nucleic acids with the electron microscope, III. Chemistry and microscopy of guanine-labeled DNA, PNAS 53:564-71 (1965). In one example of the technique, individual DNA molecules are labeled using metallic labels that are distinguishable using an electron microscope. These molecules are then stretched on a flat surface and imaged using an electron microscope to measure sequences.

Sequencing generates a plurality of reads. Reads generally include sequences of nucleotide data less than about 150 bases in length, or less than about 90 bases in length. In certain embodiments, reads are between about 80 and about 90 bases, e.g., about 85 bases in length. In some embodiments, these are very short reads, i.e., less than about 50 or about 30 bases in length. With continued reference to FIG. 1, after obtaining 101 sequence reads, a simulated mutation is introduced into one or more of the reads. A simulated mutation can include a change (an “edit”) to data within a read file. A read file may be edited to correspond to known genotype—the “expected” genotype. Any expected genotype can be used and any simulation can be introduced into the sequence reads including, for example, single mutations or combinations of mutations.

Then the sequence reads are analyzed to determine a genotype (the “observed” genotype). A set of sequence reads can be analyzed by any suitable method known in the art. For example, in some embodiments, sequence reads are analyzed by hardware or software provided as part of a sequence instrument. In some embodiments, individual sequence reads are reviewed by sight (e.g., on a computer monitor). A computer program may be written that pulls an observed genotype from individual reads. In certain embodiments, analyzing the reads includes assembling the sequence reads and then genotyping the assembled reads.

Sequence assembly can be done by methods known in the art including reference-based assemblies, de novo assemblies, assembly by alignment, or combination methods. Assembly can include methods described in U.S. Pat. No. 8,209,130 titled Sequence Assembly by Porecca and Kennedy, the contents of each of which are hereby incorporated by reference in their entirety for all purposes. In some embodiments, sequence assembly uses the low coverage sequence assembly software (LOCAS) tool described by Klein, et al., in LOCAS-A low coverage sequence assembly tool for re-sequencing projects, PLoS One 6(8) article 23455 (2011), the contents of which are hereby incorporated by reference in their entirety. Sequence assembly is described in U.S. Pat. No. 8,165,821; U.S. Pat. No. 7,809,509; U.S. Pat. No. 6,223,128; U.S. Pub. 2011/0257889; and U.S. Pub. 2009/0318310, the contents of each of which are hereby incorporated by reference in their entirety.

Making reference to FIG. 1, analyzing 109 the sequence reads (e.g., after assembly) includes obtaining an observed genotype. By comparing 113 the observed genotype to the expected genotype, the validity of the analytical pipeline can be assessed.

One insight of the invention is that, by introducing simulated mutations into the sequence reads, genetic context is preserved. Genetic context can actually influence the success or outcome of an analysis. For example, where a sample of genetic material contains a single nucleotide polymorphism SNP relative to a reference, with no other variants in proximity to the SNP, some analytical pipelines will detect that SNP in the sample material. However, where that SNP is very close to (e.g., within 25 or fewer, such as within about 5 base-pairs of) an insertion or deletion (indel), those same analytical pipelines may fail to detect the SNP in the sample material. Thus, it is possible that the genetic context of the SNP interferes with the ability of a genetic test to detect the mutation.

Methods of the invention include introducing a simulated mutation (e.g., the SNP and proximal indel just discussed) into the sequence reads. This way, the genetic context is preserved. For example, if a read assembly algorithm fails to detect the inserted SNP when it is proximal to an indel, by including the genetic context provided by the actual reads from the sequencing instrument run, the failure of the algorithm will be revealed.

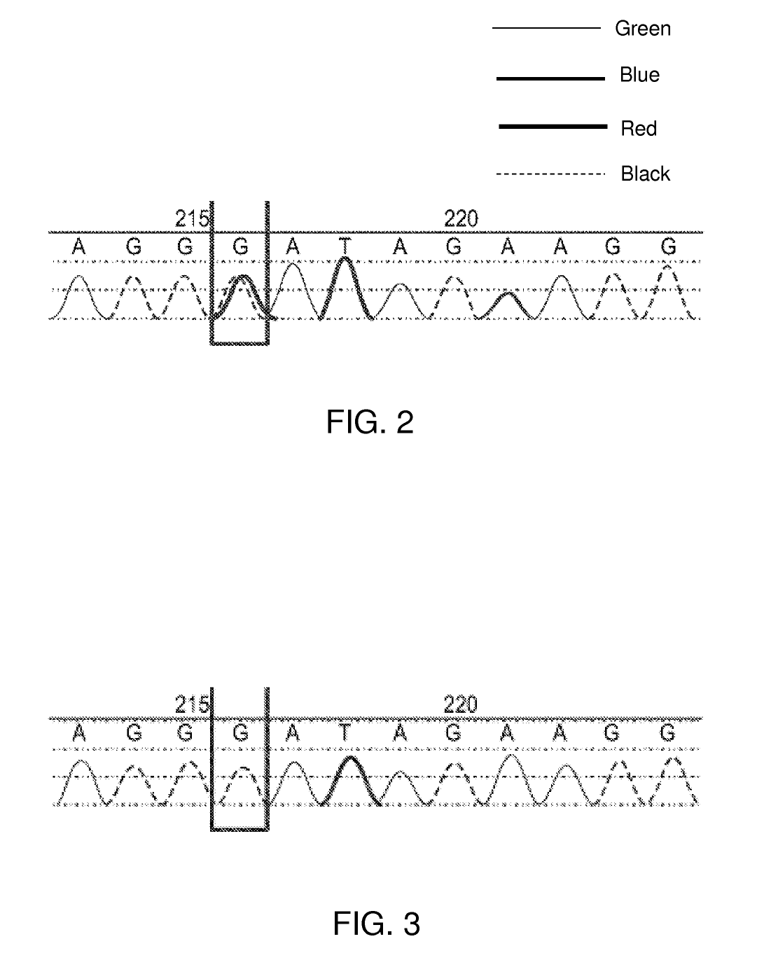

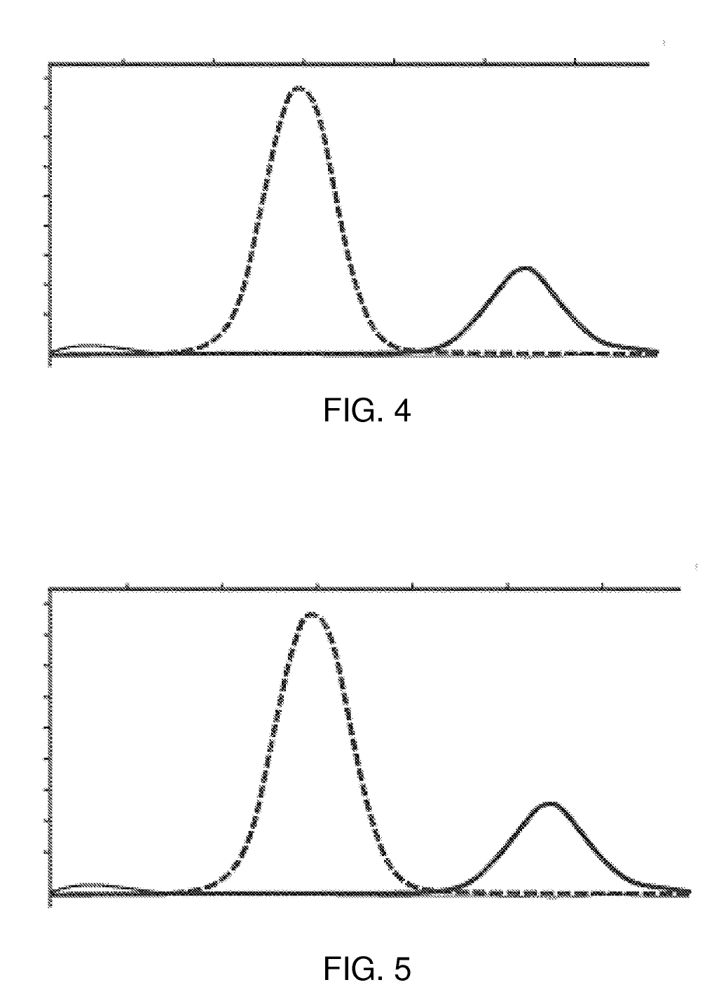

FIGS. 2-5 depict hypothetical results of evaluating the validity of an NGS analysis pipeline. Specifically, FIG. 2 represents Sanger results for heterozygous sample. FIG. 3 represents Sanger results for homozygous sample. FIG. 4 represents NGS results for heterozygous sample. FIG. 5 represents NGS results for homozygous sample.

In this hypothetical, sample and sample 2 are tested and a simulated G/T heterozygous mutation is introduced at nucleotide 216 in sample 1 (FIGS. 2 & 4 represent the heterozygous mutated sample 1; FIGS. 3 & 5 represent the homozygous G sample 2). In this hypothetical, FIGS. 2 & 3 represent Sanger sequencing results and FIGS. 4 & 5 represent results from a putative new NGS pipeline. Sanger sequencing shows a G/T base call for nucleotide 216 in sample 1, the heterozygous mutant (FIG. 2) while the NGS pipeline yielded a homozygous G base call (FIG. 4) for sample 1. The non-modified sample 2 reads were called as homozygous by both Sanger and NGS (FIGS. 3 & 5, respectively).

Specifically, in FIG. 2, a first allele in sample 1 shows as having a G at position 216 (dashed line in chromatogram in FIG. 2) and a second allele in sample 1 shows as having a T at position 216 (bold solid line in chromatogram in FIG. 2. Thus, the first allele is associated with sequence AGGGATAGAAGG (SEQ ID NO: 1). The second allele is associated with AGGTATAGAAGG (SEQ ID NO: 2). The only allele shown to be present in sample 2 can be read from the chromatogram of FIG. 3 and is associated with sequence AGGGATAGAAGG (SEQ ID NO: 1).

Since the observed homozygous NGS genotype for sample 1 does not match the expected heterozygous genotype, it is revealed that the putative new NGS pipeline is not sensitive to the n.216G>C mutation in sample 1. Since this simulated mutation was introduced by a computer into the sequence reads, all contextual information associated with those reads has the same influence on the analysis as it would have if the simulated mutation had actually been present in the original biological sample.

It is theorized that the sensitivity of an NGS analysis pipeline relates to the nature of the mutations present, the sequencing coverage, and sequencing errors. For example, some mutations by their nature are particularly difficult for some NGS platforms to pick up. A very long indel, an indel at or near an end of a read, or a substitution close to a long indel can produce reads that NGS platforms do not assemble correctly. Some sequencing methodologies are prone to sequencing errors when sequencing polynucleotide repeats. By using a computer system to reproduce these genetic patterns, the ability of the NGS platform to reliably detect those patterns is ascertained.

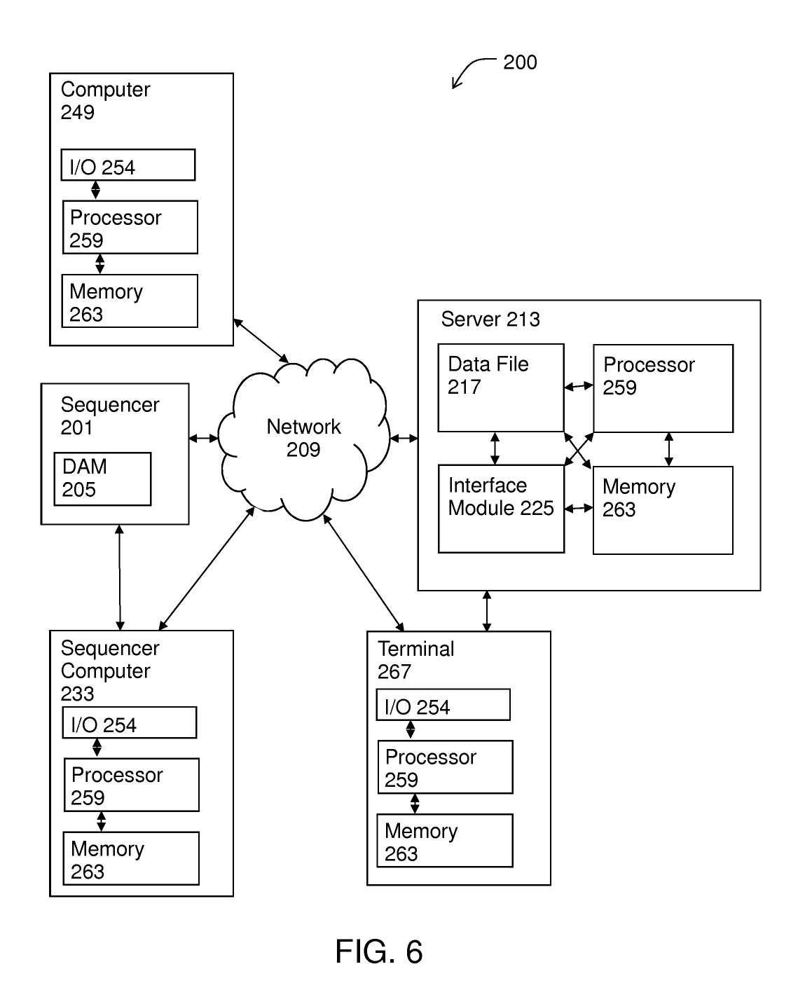

FIG. 6 shows a computer system 200 for genetic testing that is operable to evaluate the validity of genetic tests. Computer system 200 can optionally include a sequencer 201 with data acquisition module 205 to obtain sequence read data. It should be noted that methods may be performed by a single computer or any combination of elements shown in system 200. Sequencer 201 may optionally include or be operably coupled to its own, e.g., dedicated, sequencer computer 233 (including an input/output mechanism 354, one or more of processor 259 and memory 263). Additionally or alternatively, sequencer 201 may be operably coupled to a server 213 or computer 249 (e.g., laptop, desktop, or tablet) via network 209. Computer 249 includes one or more processor 259 and memory 263 as well as an input/output mechanism 254. Where methods of the invention employ a client/server architecture, any steps of methods of the invention may be performed using server 213, which includes one or more of processor 259 and memory 263, capable of obtaining data, instructions, etc., or providing results via interface module 225 or providing results as a file 217. Server 213 may be engaged over network 209 through computer 249 or terminal 267, or server 213 may be directly connected to terminal 267, including one or more processor 259 and memory 263, as well as input/output mechanism 254.

System 200 or machines therein may include for any of I/O 254 a video display unit (e.g., LED, LCD, or cathode ray tube (CRT)), an alphanumeric input device (e.g., a keyboard), a cursor control device (e.g., a mouse or trackpad), a disk drive unit, a signal generation device (e.g., a speaker), a touchscreen, an accelerometer, a microphone, a cellular radio frequency antenna, network interface device (e.g., a network interface card (NIC), Wi-Fi card, or cellular modem), or combination thereof. Processor 259 can include one or more microchips such as a Intel or AMD processor. Memory 263 can include a non-transitory machine-readable medium on which is stored one or more sets of instructions (e.g., software) embodying any one or more of the methodologies or functions described herein. While the machine-readable medium can in an exemplary embodiment be a single medium, the term “machine-readable medium” should be taken to include a single medium or multiple media (e.g., a centralized or distributed database, and/or associated caches and servers) and may include, without limit, solid-state memories (e.g., subscriber identity module (SIM) card, secure digital card (SD card), micro SD card, or solid-state drive (SSD)), optical and magnetic media, and any other tangible storage media. The software may also reside, completely or at least partially, within the main memory and/or within the processor during execution thereof by the computer system, the main memory and the processor also constituting machine-readable media. The software may further be transmitted or received over a network via the network interface device.

As depicted in FIG. 6, computer system 200 is operable to receive a plurality of sequence reads and introduce a simulated mutation into at least one of the reads. Any one or combination of the computers in system 200 may be programmed to modify sequence read files. A program may be written in any suitable language including compiled or non-complied languages. Suitable programming languages include C, C++, Perl, Python, Ruby, Groovy, Java, other suitable programming languages known in the art, or a combination thereof.

A computer program can obtain data describing the mutation(s) to be simulated from any suitable source. In some embodiments, data for simulated mutations is obtained from a genetic database or file of genetic data. In certain embodiments, data is obtained by analyzing sequence reads from prior analyses. Data describing the mutation(s) to be simulated may be obtained by human input (e.g., from reviewing medical literature) or by automated processes (e.g., such as parsing a file or a web source for certain types of information using, for example, pattern matching, which may be implemented through the use of regular expressions).

Systems and methods of the invention may be used to evaluate the validity of (e.g., validate) an analytical method, system, or combination thereof used in genetic testing. Methods of the invention include inserting simulated mutations into a limited number of sequence reads during a genetic analysis to provide a control. Other applications for systems and methods of the invention include testing the detectability of a mutation. For example, where a mutation is known or suspected, whether it is abundant, rare, very rare, or of unknown prevalence, the invention provides the ability to evaluate whether that mutation will be detected by known systems and methods. In certain embodiments, the invention provides the ability to test a proposed genetic analysis method, such as a new molecular assay, a sequencing instrument in development, or to test an assembly or genotyping algorithm by comparison to another algorithm.

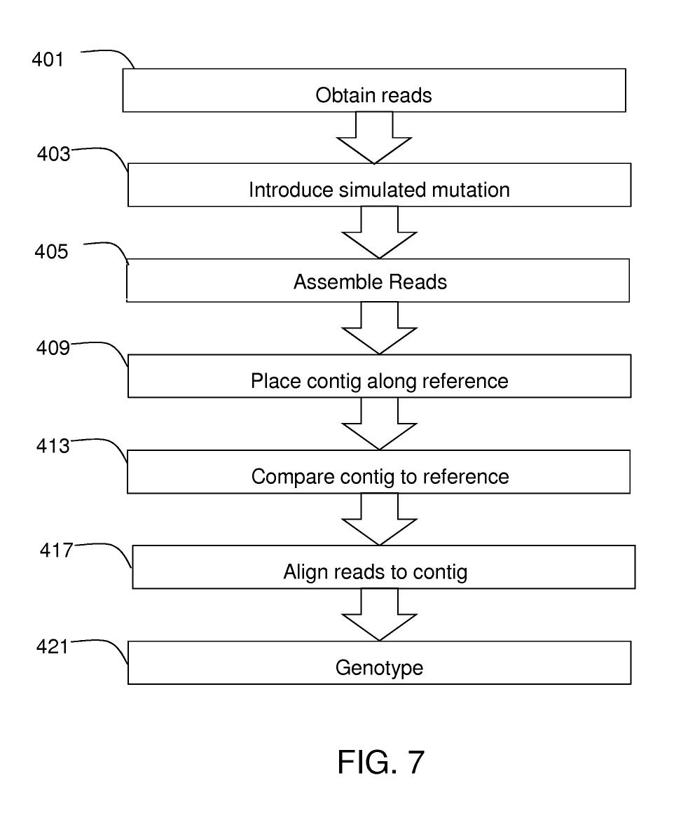

FIG. 7 diagrams the validation of a genotyping by assembly-templated alignment (GATA) technique. Genetic analysis by GATA-based methods includes obtaining 401 sequence reads and assembling 405 the reads into a contig, which is then aligned 409 to a reference. Differences are identified by comparison 413. The raw reads are aligned 417 to the contigs and positional and variant information is mapped to the reads from the reference via the contig, allowing genotyping 421 to produce an observed genotyping. The GATA-based method is evaluated by introducing 403 at least one simulated mutation into the reads.

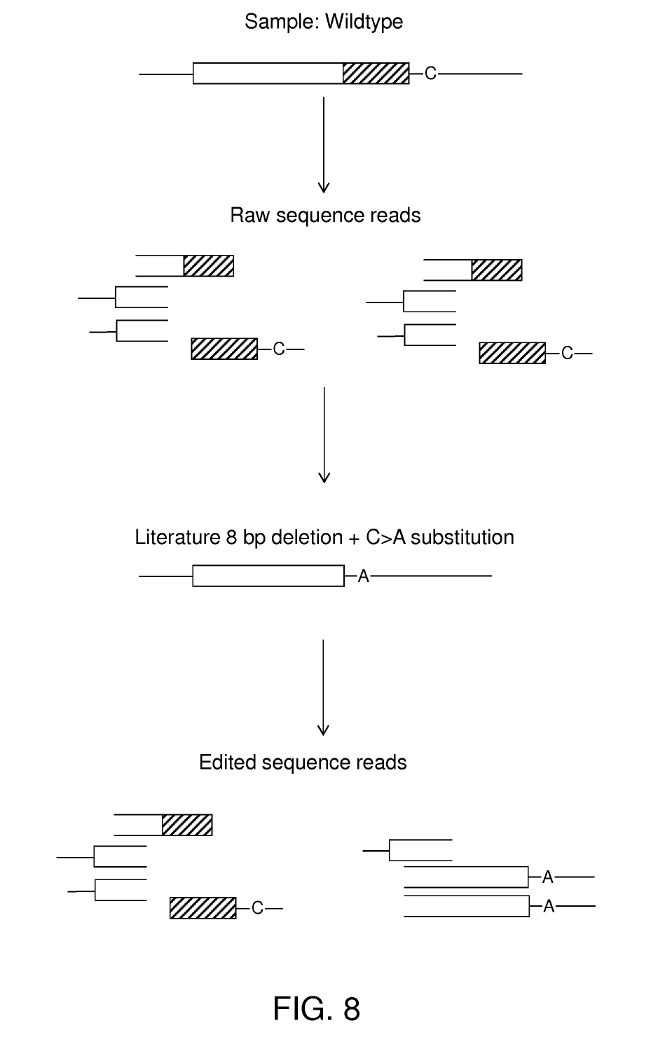

FIG. 8 illustrates obtaining sequence reads and inserting a simulated mutation. As shown in FIG. 8, if only wild type sample is sequenced, the raw sequence reads may only include wild type sequence. However, a mutation of interest may be known, for example, from the literature or it may be desirable to simply invent a difficult-to-detect mutation to use in methods of validating a genetic analysis. Here, a hypothetical 8 base pair deletion proximal to a C>A substitution is depicted. As shown in FIG. 8, the raw sequence reads are edited so that they include base sequence data, quality data, or both that would arise from sequencing the simulated mutation.

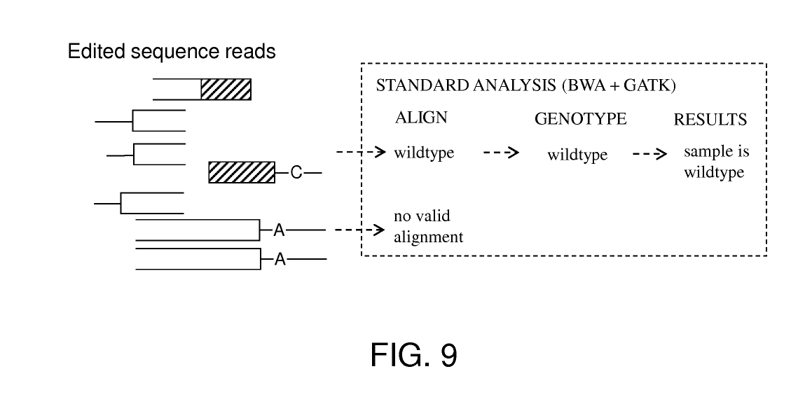

FIG. 9 shows an example in which a standard analytical method is performed for comparison to a GATA-based method. The standard analysis is demonstrated to not be able to detect a mutation. FIG. 9 depicts a workflow in which edited sequence reads (e.g., as depicted in FIG. 8) are aligned to a reference genome (here, using BWA and GATK). The alignment software properly aligns the wild type sequence reads to the reference genome, finding a perfect match and giving a result indicating that the sample is the wild type. However, the alignment software finds no valid alignment for the edited sequence reads and is unable to produce a result. Due to the fact that the expected genotype of the edited sequence reads is known a priori (and, in fact intentionally supplied by editing), an operator is able to identify that this analysis method—alignment of sequence reads to a reference genome—is incapable of detecting the mutation. For comparison, the sequence reads are also analyzed by a GATA-based method.

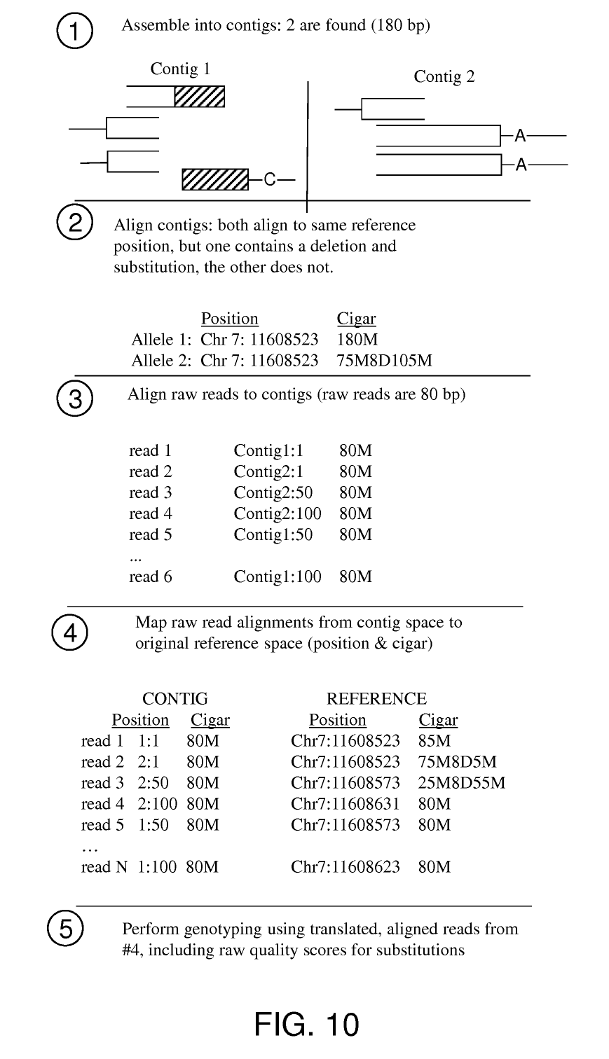

FIG. 10 shows analysis of sequence reads that include simulated mutations by GATA. In step 1, reads are assembled into contigs. Assembly can include any method including those discussed below. In step 2, each contig is aligned to a reference genome. Alignment can be by any method such as those discussed below, including, e.g., the bwa-sw algorithm implemented by BWA. As shown in FIG. 10, both align to the same reference position. Differences between the contig and the reference genome are identified and, as shown in FIG. 10, described by a CIGAR string.

In step 3, raw reads are aligned to contigs (using any method such as, for example, BWA with bwa-short and writing, for example, a CIGAR string). At step 4, raw read alignments are mapped from contig space to original reference space (e.g., via position and CIGAR information). In step 5, genotyping is performed using the translated, aligned reads from step 4 (e.g., including raw quality scores for substitutions).

For step 1, reads may be assembled into contigs by any method known in the art. Algorithms for the de novo assembly of a plurality of sequence reads are known in the art. One algorithm for assembling sequence reads is known as overlap consensus assembly. Assembly with overlap graphs is described, for example, in U.S. Pat. No. 6,714,874. In some embodiments, de novo assembly proceeds according to so-called greedy algorithms, as described in U.S. Pub. 2011/0257889, incorporated by reference in its entirety. In other embodiments, assembly proceeds by either exhaustive or heuristic pairwise alignment. Exhaustive pairwise alignment, sometimes called a “brute force” approach, calculates an alignment score for every possible alignment between every possible pair of sequences among a set. Assembly by heuristic multiple sequence alignment ignores certain mathematically unlikely combinations and can be computationally faster. One heuristic method of assembly by multiple sequence alignment is the so-called “divide-and-conquer” heuristic, which is described, for example, in U.S. Pub. 2003/0224384. Another heuristic method of assembly by multiple sequence alignment is progressive alignment, as implemented by the program ClustalW (see, e.g., Thompson, et al., Nucl. Acids. Res., 22:4673-80 (1994)).

With continuing reference to step 1 of FIG. 10, in some embodiments assembly into contigs involves making a de Bruijn graph. De Bruijn graphs reduce the computation effort by breaking reads into smaller sequences of DNA, called k-mers, where the parameter k denotes the length in bases of these sequences. In a de Bruijn graph, all reads are broken into k-mers (all subsequences of length k within the reads) and a path between the k-mers is calculated. In assembly according to this method, the reads are represented as a path through the k-mers. The de Bruijn graph captures overlaps of length k-1 between these k-mers and not between the actual reads. By reducing the entire data set down to k-mer overlaps, the de Bruijn graph reduces the high redundancy in short-read data sets. Assembly of reads using de Bruijn graphs is described in U.S. Pub. 2011/0004413, U.S. Pub. 2011/0015863, and U.S. Pub. 2010/0063742, incorporated by reference in their entirety. Assembly of reads into contigs is further discussed in U.S. Pat. No. 6,223,128, U.S. Pub. 2009/0298064, U.S. Pub. 2010/0069263, and U.S. Pub. 2011/0257889, each of which is incorporated by reference herein in its entirety.

Computer programs for assembling reads are known in the art. Such assembly programs can run on a general-purpose computer, on a cluster or network of computers, or on a specialized computing devices dedicated to sequence analysis as depicted, for example, in FIG. 6.

Assembly can be implemented, for example, by the program ‘The Short Sequence Assembly by k-mer search and 3′ read Extension’ (SSAKE), from Canada's Michael Smith Genome Sciences Centre (Vancouver, B.C., CA) (see, e.g., Warren, R., et al., Bioinformatics, 23:500-501 (2007)). SSAKE cycles through a table of reads and searches a prefix tree for the longest possible overlap between any two sequences. SSAKE clusters reads into contigs.

Another read assembly program is Forge Genome Assembler, written by Darren Platt and Dirk Evers and available through the SourceForge web site maintained by Geeknet (Fairfax, Va.) (see, e.g., DiGuistini, S., et al., Genome Biology, 10:R94 (2009)). Forge distributes its computational and memory consumption to multiple nodes, if available, and has therefore the potential to assemble large sets of reads. Forge was written in C++ using the parallel MPI library. Forge can handle mixtures of reads, e.g., Sanger, 454, and Illumina reads.

Other read assembly programs include Clustal Omega, (Sievers F., et al., Mol Syst Biol 7 (2011)), ClustalW, or ClustalX (Larkin M. A., et al., Bioinformatics, 23, 2947-2948 (2007)) available from University College Dublin (Dublin, Ireland); Velvet, available through the web site of the European Bioinformatics Institute (Hinxton, UK) (Zerbino D. R. et al., Genome Research 18(5):821-829 (2008)); programs from the package SOAP, available through the website of Beijing Genomics Institute (Beijing, CN) or BGI Americas Corporation (Cambridge, Mass.); ABySS, from Canada's Michael Smith Genome Sciences Centre (Vancouver, B.C., CA) (Simpson, J. T., et al., Genome Res., 19(6):1117-23 (2009)); and Roche's GS De Novo Assembler, known as gsAssembler or “Newbler” (NEW assemBLER), which is designed to assemble reads from the Roche 454 sequencer (described, e.g., in Kumar, S. et al., Genomics 11:571 (2010) and Margulies, et al., Nature 437:376-380 (2005)). Newbler accepts 454 Flx Standard reads and 454 Titanium reads as well as single and paired-end reads and optionally Sanger reads. Newbler is run on Linux, in either 32 bit or 64 bit versions. Newbler can be accessed via a command-line or a Java-based GUI interface. Other read assembly programs include Cortex; RTG Investigator; iAssembler; TgiCL Assembler; Maq; MIRA3; PGA4genomics; and Phrap.

Assembly of reads produces one or more contigs. As shown in Step 2 of FIG. 10, a contig may then be aligned to a reference genome. Alignment, as used herein, generally involves placing one sequence along another sequence, iteratively introducing gaps along each sequence, scoring how well the two sequences match, and preferably repeating for various position along the reference. Alignment according to some embodiments of the invention includes pairwise alignment. In some embodiments, pairwise alignment proceeds according to dot-matrix methods, dynamic programming methods, or word methods. Dynamic programming methods may implement the Smith-Waterman (SW) algorithm or the Needleman-Wunsch (NW) algorithm as described, for example, in U.S. Pat. No. 5,701,256 and U.S. Pub. 2009/0119313, both herein incorporated by reference in their entirety.

In certain embodiments, the invention provides methods of alignment which avoid an exhaustive pairwise alignment by making a suffix tree (sometime known as a suffix trie). Given a reference genome T, a suffix tree for T is a tree comprising all suffices of T such that each edge is uniquely labeled with a character, and the concatenation of the edge labels on a path from the root to a leaf corresponds to a unique suffix of T. A Burrows-Wheeler transform (BWT) can be used to index reference T, and the index is used to emulate a suffix tree. One exemplary computer alignment program that implements a BWT is Burrows-Wheeler Aligner (BWA) available from the SourceForge web site maintained by Geeknet (Fairfax, Va.). Alignment by BWA can proceed using the algorithm bwa-short, designed for short queries up to ˜200 base pair with low error rate (<3%) (Li H. and Durbin R. Bioinformatics, 25:1754-60 (2009)). The second algorithm, BWA-SW, is designed for long reads with more errors (Li H. and Durbin R. (2010) Fast and accurate long-read alignment with Burrows-Wheeler Transform. Bioinformatics, Epub.). The BWA-SW component performs heuristic Smith-Waterman-like alignment to find high-scoring local hits. One skilled in the art will recognize that bwa-sw is sometimes referred to as “bwa-long”, “bwa long algorithm”, or similar. Such usage generally refers to BWA-SW.

Other exemplary alignment programs include: Efficient Large-Scale Alignment of Nucleotide Databases (ELAND) or the ELANDv2 component of the Consensus Assessment of Sequence and Variation (CASAVA) software (Illumina, San Diego, Calif.); RTG Investigator; Novoalign; MUMmer; BLAT; SOAP2; and Bowtie.

With each contig aligned to the reference genome, individual reads are aligned 117 (Step 3 in FIG. 10) to the contigs, and positional and variant information is mapped from the reference to the individual reads through the contig, as shown in 4 of FIG. 10.

Proceeding by the above-described GATA method, it may be found that the simulated mutation inserted into the sequence reads is detected, due to the sensitivity of the GATA method, where the mutation was not detected by the standard analysis referenced in FIG. 9. Accordingly, the invention provides methods for evaluating the sensitivity of a genetic analysis or genetic test.

While discussed above generally in terms of evaluating sequence read assembly algorithms, it will be appreciated that systems and methods of the invention may be used to evaluate any genetic pipeline, including any component or aspect of a pipeline. For example, upon the design and introduction of a new set of molecular inversion probes, those probes can be tested by using them to generate sequence reads, introducing a simulated mutation into the sequence reads, and comparing the results of genotyping those modified sequence reads to an expected genotype associated with the introduced, simulated mutation.

In another embodiment, the invention provide the ability to test a new nucleic acid sequencer 201 (FIG. 6). To illustrate, sequencer 201 may be operated on a sample to generate a plurality of reads. A computer (e.g., server 213 in FIG. 6) may be programmed to insert one or any number of simulated mutations into those reads. The reads are genotyped to determine if the sequencer produced sequence reads that are amenable to genotyping. By using, for example, a powerful computer, cluster, or network of computers for server 213, a data throughput can be provided that is commensurate with the output of NGS sequencers.

In some embodiments, the invention provides methods to evaluate the detectability of a mutation. For example, if a new mutation is reported in the literature (e.g., and a biological specimen is not to be had), a simulation of that mutation may be introduced into sequence reads. Moreover, even where a biological specimen is available, testing detectability according to methods of the invention allows the detectability to be tested with the mutation in a plurality of different hypothetical genetic contexts. For example, a new substitution may be reported and only one or a very few examples may be known. If it is deemed important to assay for that substitution in the context of other mutations (e.g., in cis with a deletion), methods of the invention may be employed to do so. Further, methods of the invention may be employed to rapidly test a very large number of sequence reads and run a very large number of tests. For example, for a list of ten known mutations, the detectability of every possible combination could be tested in a few hours. Greater than hundreds to thousands of mutations or combinations of mutations may be introduced, in greater than hundreds or thousands of replicates (e.g., millions) within less than hours in some embodiments. Where ample processing speed is included, millions of mutations can be introduced into files in tens of minutes or minutes.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

### EXAMPLES

### Example 1

### NGS Workflow

An exemplary sequencing workflow is an NGS-based workflow that combines automated molecular inversion probe target capture with molecular barcoding to maximize the sample throughput of a next-generation DNA sequencing machine, and employs a novel genotyping by assembly-based alignment (GATA) method that provides accurate identification of both substitution and insertion/deletion lesions.

This workflow includes sequencing the protein-coding regions of fifteen genes in which loss-of-function mutations cause recessive Mendelian disorders often included as part of routine carrier screening, and demonstrates through realistic simulation and comparison to Sanger sequencing data that the approach achieves high accuracies and detects the vast majority of disease-causing mutations.

### Methods

### Molecular Inversion Probe Design

Molecular inversion probes were designed to capture the coding regions and certain well-characterized non-coding regions of 15 genes. The 5′ targeting arm (ligation arm) and 3′ targeting arm (extension arm) comprised a total of 40 nucleotides, and were designed to flank 130 base pair target regions. Probes were selected to maximize performance with respect to both capture efficiency and robustness to common polymorphisms. All possible probes targeting a genomic interval were designed and assigned score tuples consisting of: 1) presence of guanine or cytosine as the 5′-most base of the ligation arm, 2) the number of dbSNP (version 130) entries intersecting targeting arm sites, and 3) the root mean squared deviation of the arms' predicted melting temperatures from optimal values derived from empirical studies of capture efficiency. Using these tuples, probes were ranked sequentially by 1, 2, and 3, and the probe with the highest rank was chosen. Probes were designed to ‘tile’ across targets with a period of 25 base pair such that every genomic position was captured by multiple probes with orthogonal targeting arm sequences.

### Target Capture, Barcoding, and NGS

Genomic DNA was purchased from the Coriell Cell Repositories (Camden, N.J.) or isolated from whole blood by the Gentra Puregene method (Qiagen) modified to conclude with an overnight incubation at 65° C. On Tecan automation, 1.5 μg of genomic DNA was annealed with 1 μl of molecular inversion probe mix in 1× Ampligase buffer (Epicentre Biotechnologies) for 5 min at 95° C. followed by 24 hr at 54° C. 17 μl of fill-in mix (4 U Taq stoffel fragment [Life Technologies], 10 U Ampligase [Epicentre Biotechnologies], 23.1 μM dNTP mix) was added by Tecan automation and incubated for 1 hr at 54° C. 3 μl of exonuclease mix (50 U Exonuclease 1 and 50 U Exonuclease III [Enzymatics Inc.] in 1× Ampligase buffer) was then added by Tecan automation and incubated for 1 hr at 37° C. followed by 10 min at 98° C. The capture reaction product was amplified in two separate PCR reactions designed to attach a molecular barcode and Illumina cluster amplification sequences to the ends of each molecule so as to enable sequencing from each end of the captured region. Tecan automation was used to set up the PCR, which was carried out with 3.75 μl of capture product, 15 pmol of each primer, 10 nmol dNTPs, and 1 U VeraSeq polymerase (Enzymatics, Inc.) in 1× Veraseq buffer. Cycling conditions were: 98° C. 30 sec, 21× (98° C. 10 sec, 54° C. 30 sec, 72° C. 15 sec), 4° C. forever.

Following PCR, equal volumes of product from multiple samples were pooled using Tecan automation, then purified using a Qiaquick column (Qiagen). The library pool concentration was quantified on a Bioanalyzer 2100 (Agilent Technologies) and diluted to 10 nM. Single-read sequencing (85 bp for genomic tag and 15 bp for barcode/index) was performed on the Hiseq 2000 from Illumina, Inc., according to the manufacturer's instructions. Each pool of libraries was sequenced in 7 lanes, with the 8th lane used for the manufacturer-supplied PhiX control library.

NGS Data Analysis with Alignment Only

Raw .bcl files were converted to qseq files using bclConverter (Illumina). Fastq files were generated by ‘de-barcoding’ genomic reads using the associated barcode reads; reads for which barcodes yielded no exact match to an expected barcode, or contained one or more low-quality basecalls, were discarded. The remaining reads were aligned to hg18 on a per-sample basis using BWA version 0.5.7 for short alignments, and genotype calls were made using GATK version 1.0.4168 after base quality score re-calibration, realignment (with GATK version 1.0.5083), and targeting arm removal. High-confidence genotype calls were defined as having depth>=50 and strand bias score<=0. Clinical significance of variant calls was determined by matching against a VCF-formatted database of disease-causing mutations curated from the literature, with equivalent insertion/deletion regions calculated as described in literature.

NGS Data Analysis with Genotyping by Assembly-Templated Alignment

De-barcoded fastq files were obtained as described above and partitioned by capture region (exon) using the target arm sequence as a unique key. Reads were assembled in parallel by exon using SSAKE version 3.7 with parameters “−m 30−o 15”. The resulting contigs were aligned to hg18 using BWA version 0.5.7 for long alignments with parameter “−r 1”. Short read alignment was performed as described above except that sample contigs (rather than hg18) were used as the input reference sequence. Software was developed in Java to accurately transfer coordinate and variant data (gaps) from local sample space to global reference space for every BAM-formatted alignment. Genotyping and base quality recalibration were performed on the coordinate-translated BAM files using GATK version 1.6.5.

### Sanger Sequencing

PCR was carried out with the genomic DNA described in Target capture, barcoding, and NGS. Briefly, 15 μl reactions were conducted with 25 ng of genomic DNA, 1U of AmpliTaq Gold (Applied Biosystems), and 10 fmol of each PCR primer in a PCR mix containing 4.8% DMSO (v/v), 1M betaine, 2.5 mM magnesium chloride, 1 μM dNTPs (total), and 1× GeneAmp PCR Gold Buffer (Applied Biosystems). Cycling conditions were: 95° C. 10 min, 30× (95° C. 30 sec, 60° C. 30 sec, 72° C. 30 sec), 72° C. 10 min, 8° C. forever. PCR products were sent to either Beckman Coulter Genomics or Genewiz where cleanup and chain termination bi-directional Sanger sequencing was performed on an ABI 3730×1 according to standard protocols. Data was retrieved in electropherogram (ab1) format.

### Sanger Data Analysis and Cross-Validation to NGS

Mutation Surveyor software version 4.0.5 (“MS”) from SoftGenetics, LLC (State College, Pa.) was used in batch-mode with default parameters to align ab 1 files to target reference sequence and make genotype calls. The MS software is described in Dong and Yu, 2011, Mutation Surveyor: an in silico tool for sequencing analysis, Methods Mol Biol 760:223-37 and in Minton, et al., 2011, Mutation Surveyor: software for DNA sequence analysis, Methods Mol Biol 688:143-53. Positions where MS base calls did not match in the forward and reverse directions were removed from consideration. All high-quality NGS genotype calls within 10 bp (inclusive) of target exons were subjected to cross-validation against VCF-converted MS variant calls. Calls were compared by (i) lesion type (substitution, insertion, deletion, or combination thereof), (ii) lesion pattern (sequence difference compared to the reference), and (iii) genomic position (or equivalent position for insertions and deletions). NGS calls were classified true positive (TP), discordant (non-reference) variant genotype (DVG), or false positive (FP) if they matched MS calls by (i-iii), (iii) only, or none of the above criteria, respectively. MS variant calls with no corresponding NGS variant call were classified false negative (FN). Indel calls classified as DVG were re-classified as TP because GATK 1.0.4168 does not report zygosity for such calls. All concordant reference calls were considered true negative (TN). Each discordant call (DVG, FP, and FN), along with a subset of concordant calls, was subject to expert manual review and reclassification as appropriate. False positive rate was calculated as FP/(FP+TN). False negative rate was calculated as FN/(FN+TP). Compound heterozygous NGS calls (two non-reference alleles) were cross-validated against Sanger data manually by aligning traces to a reference manipulated to contain one of the two variant alleles. In these cases TP genotype calls were reported as simple heterozygous by MS.

### Assessment of Detectability of Clinical Mutations by Simulation

145 Coriell samples were sequenced and analyzed by Genotyping by Assembly-Templated Alignment (described above). Applications were developed in Java and Groovy to input aligned reads (BAM records) from each sample and manipulate specific data fields (base sequence and qualities) to resemble the appropriate DNA lesion pattern of a given clinically relevant mutation. To simulate heterozygous carriers input reads covering the mutation were chosen at random for sequence manipulation with an average probability of 0.5. All reads, whether manipulated or not, were output in fastq format for subsequent Genotyping by Assembly-Templated Alignment (GATA) as described. This process was repeated for each of 81 mutations of clinical significance whereupon genotyped (observed) alleles were cross-referenced back to the original simulated (expected) allele. Samples for which the allele was already present were excluded from simulation (e.g. many Coriell samples in the set contained the common CFTR F508del mutation). Mutations with detection rates<100% between the expected and observed alleles were classified as undetectable by NGS.

### Determining Clinical Significance of Variant Allele Calls

Each NGS-detected variant allele is annotated for functional (clinical) significance by determining its relative position within the corresponding consensus coding sequence (CCDS). For the genes under consideration here these are: PCDH15 (CCDS7248.1), SMPD1 (CCDS44531.1), ABCC8 (CCDS31437.1), HEXA (CCDS10243.1), BLM (CCDS10363.1), ASPA (CCDS11028.1), G6PC (CCDS11446.1), MCOLN1 (CCDS12180.1), BCKDHA (CCDS12581.1), CLRN1 (CCDS3153.1), BCKDHB (CCDS4994.1), DLD (CCDS5749.1), CFTR (CCDS5773.1), FANCC (CCDS35071.1), and IKBKAP (CCDS6773.1). Clinically significant (reportable) mutations include alterations to the conserved 2 base pairs internally flanking each exon (splice site), the native start codon, or the last codon (read-through), as well as truncating (nonsense and frameshift) mutations. Additionally, GATK occasionally reports alternate insertion patterns with non-native bases (e.g. ‘N’) chosen from a minority of reads. These were classified ‘indeterminate’ and reportable.

### Results

### Completeness/Reproducibility

Automated target capture and molecular barcoding was performed followed by NGS on a set of 194 samples derived from immortalized cell lines (55 containing specific disease-causing mutations, and 139 chosen to represent ethnic diversity, and 59 samples derived from whole blood. All exons were targeted including 10 nt of flanking intronic sequence, plus additional intronic regions known to contain disease-causing mutations in 15 genes causative of 14 recessive Mendelian diseases using tiling molecular inversion probes (see Methods). A total of 25,907,612,945 base pairs of de-multiplexed sequence were generated, corresponding to an average per-base coverage per sample of 2,399× (min 891×, max 4,000×). Out of the 42,858 bases targeted for capture in each sample, high-confidence genotype calls were made at an average of 97.3% (min 92.2%, max 99.8%) for cell line-derived DNA and 99.9% (min 99.8%, max 99.9%) for blood-derived DNA.

Of note, the DNA extraction protocol used for the blood samples concluded with an overnight incubation at 65° C. in a Tris-based buffer. Subsequent experiments showed that this reduced the mean size of the purified DNA; shearing was likely caused by acid hydrolysis during a temperature-induced pH shift of the buffer (Tris-HCl). It is hypothesized that lower molecular mass genomic DNA is more readily denatured and therefore more accessible to molecular inversion probes, which improves capture reaction performance. Consistent with this hypothesis, it is found that reducing the overnight incubation temperature to 25° C. significantly reduces the percentage of target bases that yield high confidence genotype calls.

To assess reproducibility, a subset of 126 samples derived from cell line DNA was processed twice, each time by a different operator on different liquid handling equipment. At least 92% of bases were called at >=50× coverage in all samples, with high agreement between replicates (Pearson correlation coefficient 0.868). Out of 5,177,206 total genotype calls compared, 17 were discordant, for a concordance rate of 0.999997. These occurred at only 5 unique genomic positions, consistent with systematic sequencing error as the primary cause.

### Sanger Concordance

To assess the overall accuracy of the NGS genotype calls, genotype calls from the NGS pipeline were compared to those generated by automated analysis (Mutation Surveyor, MS) of bi-directional Sanger sequence of PCR amplicons in a subset of 194 samples. Within a total of 6,997,906 bp of sequence called by both methods, 3,973 concordant and 1,220 discordant single nucleotide variant (SNV) genotype calls were observed. Through manual inspection of the Sanger trace(s) corresponding to discordant genotype calls, it was determined that 1,139 were MS errors, generally caused by low quality traces or misalignment of traces to reference. Supporting the conclusion that the majority of discordant calls corresponded to incorrect Sanger calls, it was observed that the Ti/Tv ratio of concordant genotype calls was 3.19, and 0.61 for discordant Sanger calls eliminated as MS errors. The remaining 81 discordant genotype calls that could not be resolved because the corresponding traces were ambiguous, were re-amplified and re-sequenced. For 69 of these calls, this process yielded higher-quality Sanger data that led to the conclusion that the original Sanger calls were incorrect. An additional 3 discordant calls were resolved by other approaches as NGS true negatives (e.g., FIG. 4), leaving 9 high-confidence discordant SNV calls (Table 1) corresponding to 8 NGS false positives and 1 NGS false negative. Table 1 shows a comparison of NGS genotype calls (alignment-only algorithm) to Sanger-derived Mutation Surveyor genotype calls. Sanger genotype calls were considered truth. TP, true positive calls (non-reference NGS, non-reference Sanger); FP, false positive calls (non-reference NGS, reference Sanger); FN, false negative calls (reference NGS, non-reference Sanger); TN, true negative calls (reference NGS, reference Sanger). dbSNP membership determined relative to version 129. Indel calls were considered unique if they differed by sequence pattern or equivalence region. Known indels are disease-causing mutations present in previously-annotated samples.

| | | | TP | FP | FN | TN |
|---|---|---|---|---|---|---|
| SNV | Heterozygous | dbSNP | 2,474 | 0 | 1 | 5,166,654 |
| | | not dbSNP | 244 | 8 | 0 | |
| | Homozygous | dbSNP | 1,244 | 0 | 0 | |
| | | not dbSNP | 13 | 0 | 0 | |
| | Unique | | 227 | 3 | 1 | |
| Indel | Total | | 61 | 396 | 3 | |
| | Unique | | 17 | 27 | 2 | |
| | Known | | 31 | — | 0 | |

The NGS SNV false positive rate was 1.55×10⁻⁶ (95% Wilson binomial confidence interval [7.85×10⁻⁷ 3.06×10⁻⁶]). The false positive calls occurred at 5 unique genomic loci, 3 of which were at adjacent positions in a single exon of gene MCOLN1 due to realignment within GATK.

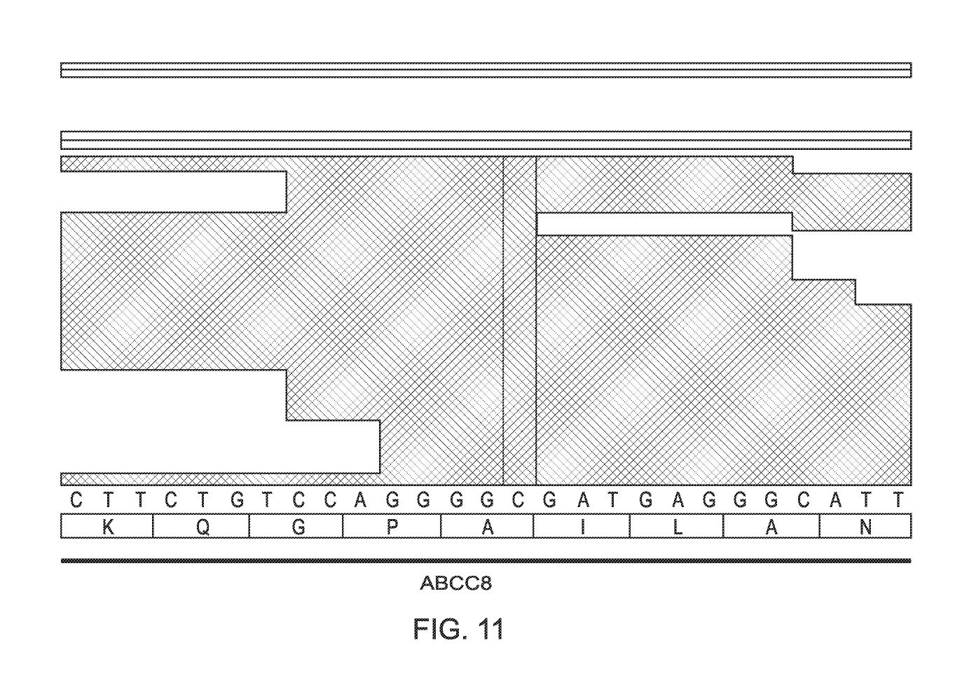

FIGS. 11-14 shows GM18540 is an aneuploid cell line and hence yields skewed allelic fractions.

FIG. 11 gives an view of NGS data from GM18540 for the genotype call of interest (shown between vertical lines) as shown by the Integrative Genomics Viewer (IGV). The IGV is discussed in Thorvaldsdottir, et al., 2012, Integrative Genomics Viewer (IGV): high-performance genomics data visualization and exploration, Brief Bioinform 24(2):178-92. The IGV view reveals the genetic sequence CTTCTGTCCAGGGGCGATGAGGGCATT (SEQ ID NO: 3). It can be noted that the sequence would translate to the amino acid sequence Lys Gln Gly Pro Ala Ile Leu Ala Asn (SEQ ID NO: 4).

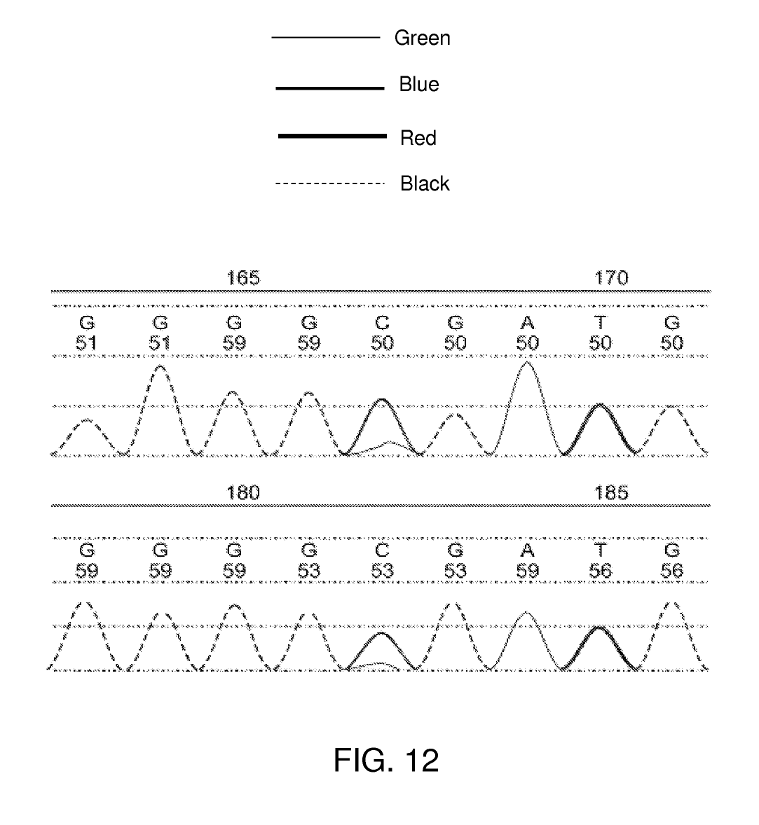

FIG. 12 shows bi-directional Sanger data for the variant-containing region.

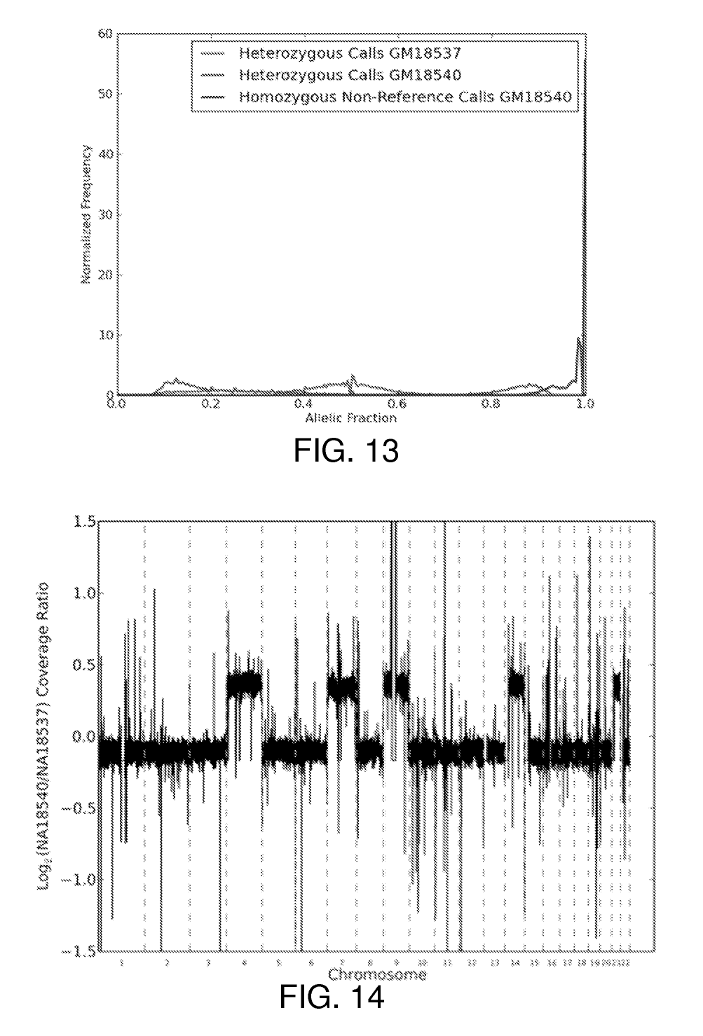

FIG. 13 provides a histogram of allele ratios for all non-reference genotype calls in chromosome 11 derived from whole-genome shotgun sequencing (WGSS) of GM18540 and control sample GM18537. FIG. 14 shows genome-wide relative coverage for GM18540. WGSS coverage data for each of the autosomes was binned into 50 Kb intervals and the log-ratio of the per-sample mean normalized values was plotted versus chromosome position. Dashed vertical lines denote chromosome boundaries; within a chromosome the ratios are arranged according to genomic position.

The NGS SNV false negative rate was 2.52×10⁻⁴ (95% Wilson binomial confidence interval [1.29×10⁻⁵ 1.42×10⁻³]). The false negative call observed occurred in chromosome 11 of a sample previously characterized as aneuploid. Out of 473 NGS reads covering the false negative locus, 9.5% supported the correct heterozygous A/C genotype call (FIG. 11), with Sanger sequencing showing low peak height for the alternate A allele (FIG. 12). Shotgun full-genome sequencing of this sample demonstrated a bimodal distribution of allele ratios for chromosomal loci which were called heterozygous (FIG. 13), and illustrated that the chromosome copy numbers were variable (FIG. 14), supporting the conclusion that this sample was aneuploid.

For indels, a total of 61 true positives, 394 false positives (27 unique alleles) and 3 false negatives (2 unique alleles, both in exon 1 of SMPD1) were observed. Of 31 clinically-relevant disease mutations, all 31 were detected.

### Detection of Pathogenic Mutations

The ability to detect variants that cause the Mendelian diseases targeted by the panel in the set of 194 cell line-derived samples was assessed (Table 2). 55 of these samples were derived from individuals who were either carriers of or affected by one of the diseases being assayed and collectively contained a total of 97 previously-characterized disease mutations. During the design of the NGS workflow, it was determined that three of these lesions would be inaccessible by the approach—two were large deletions spanning multiple exons, and one was contained within a region of paralogous sequence (Table 3). Of the 94 mutations that were expected to be detected by NGS, all 94 were detected (Table 3). Truncating (and likely disease-causing) mutations in two affected samples where previously only one mutation was known were also detected (Supplemental Table 3), as well as 9 carriers in the set of 139 previously-uncharacterized Hapmap, Thousand Genomes Project, and Human Diversity Panel samples (Table 3).

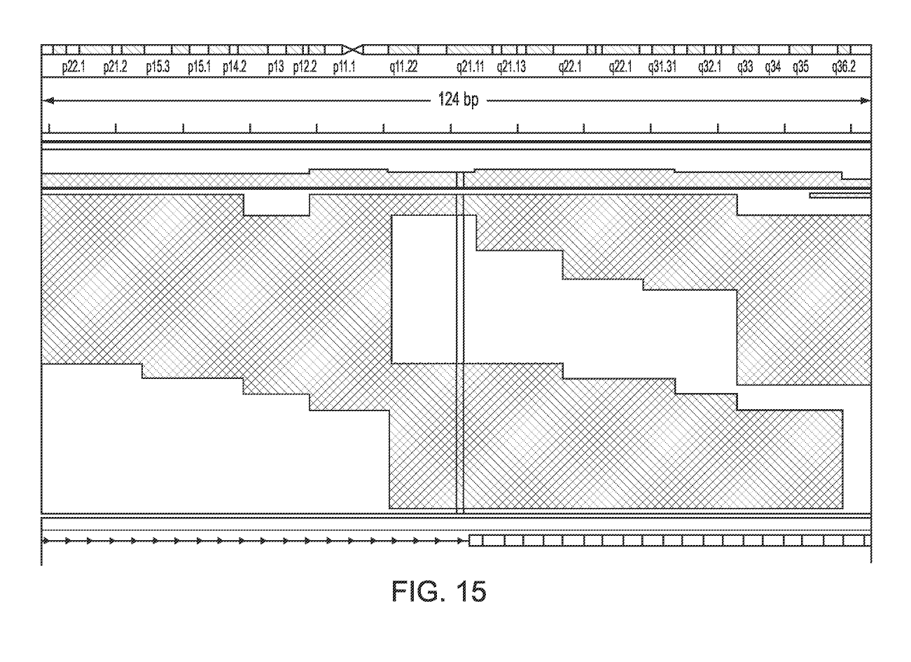

FIGS. 15-18 show detection of previously-uncharacterized mutations in samples from individuals affected with cystic fibrosis.

FIG. 15 shows an IGV view of a heterozygous splice site mutation c.3368-2A>T in sample GM12960. In FIG. 15, the line of nucleotides shown in the display reads ATAAAGTCGTTCACAGAAGAGAGAAATAACATGAGGTTCATTTACGTCTTTTGTGCA TCTATAGGAGAAGGAGAAGGAAGAGTTGGTATTATCCTGACTTTAGCCATGAATATC ATGAGTACAT (SEQ ID NO: 5). The line of amino acids reads Glu Gly Glu Gly Arg Val Gly Ile Ile Leu Thr Leu Ala Met Asn Be Met Ser Thr (SEQ ID NO: 6).

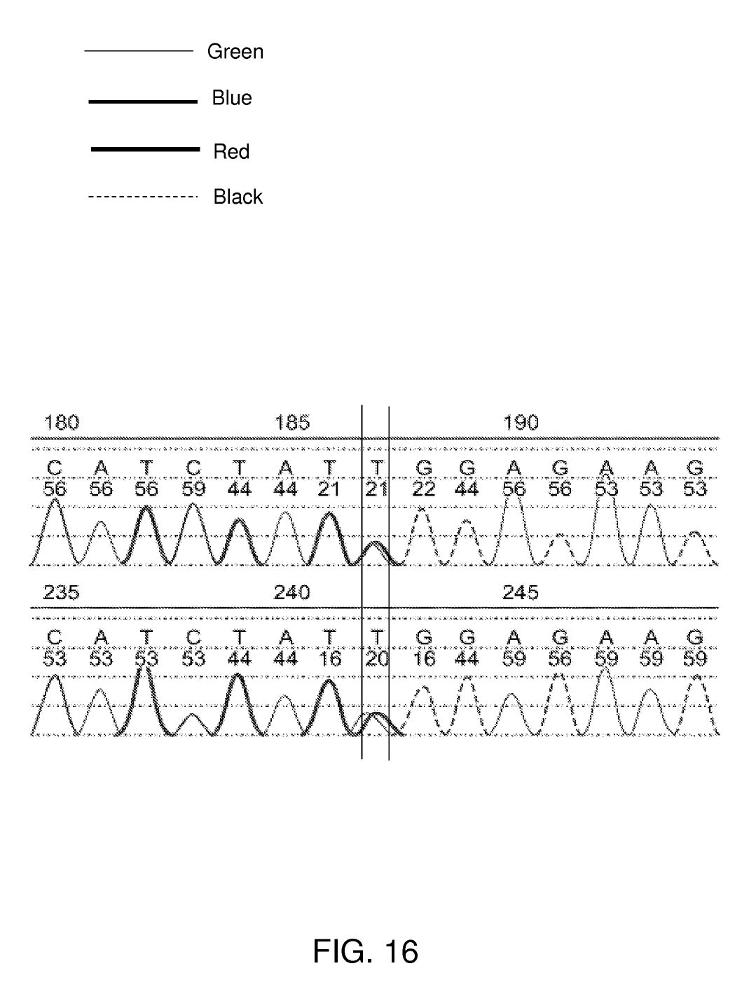

FIG. 16 shows Sanger chromatograms confirming existence of mutation c.3368-2A>T in sample GM12960. Each chromatogram is shown with the base calls indicating sequence CATCTATTGGAGAAG (SEQ ID NO: 7). In FIG. 16, vertical lines have been added to set off the base call (T) corresponding the 62nd base shown in the IGV view of FIG. 15 (i.e., an A).

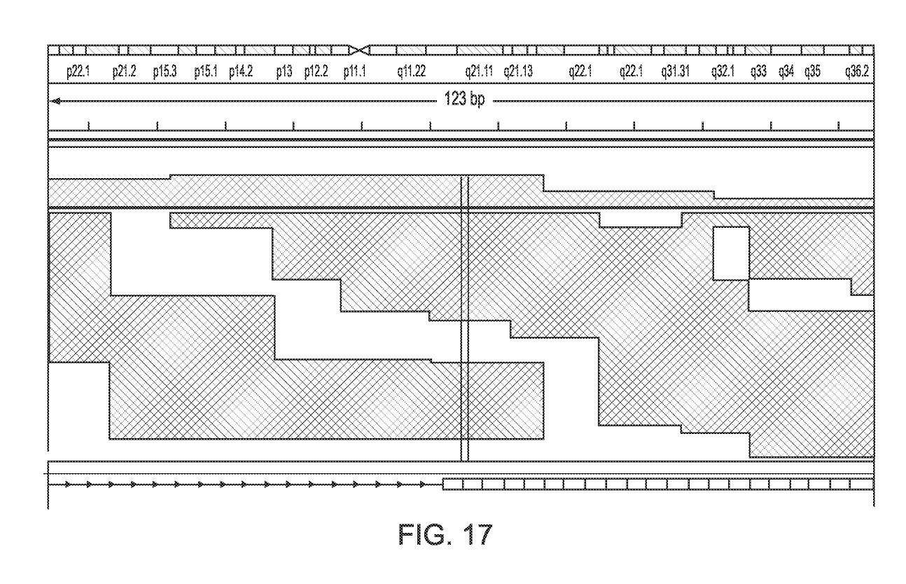

FIG. 17 shows a sample heterozygous for premature stop codon mutation R1158X in sample GM18802. In FIG. 17, the line of nucleotides shown in the display reads CTAATTGTGAAATTGTCTGCCATTCTTAAAAACAAAAATGTTGTTATTTT TATTTCAGATGCGATCTGTGAGCCGAGTCT TTAAGTTCATTGACATGCCA ACAGAAGGTAAACCTACCAAGTC (SEQ ID NO: 8). The amino acid sequence is:

Met Arg Ser Val Ser Arg Val Phe Lys Phe Ile Asp Met Pro Thr Glu Gly Lys Pro Thr Lys (SEQ ID NO: 9).

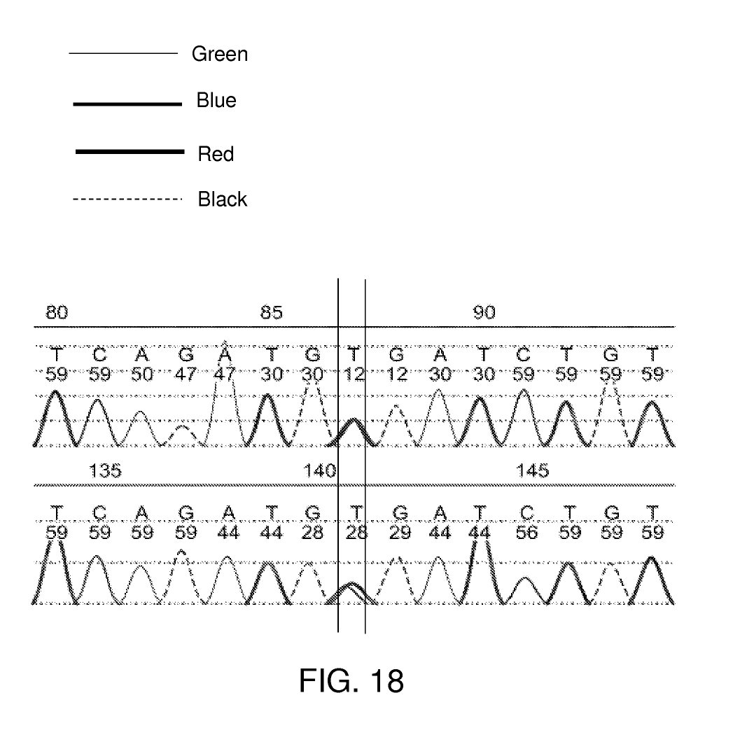

FIG. 18 depicts Sanger results confirming existence of mutation R1158X in sample GM18802. Each chromatogram is shown with the base calls indicating sequence TCAGATGTGATCTGT (SEQ ID NO: 10). In FIG. 18, vertical lines have been added to set off the location of the premature stop codon corresponding the 62nd base shown in the IGV view of FIG. 17 (i.e., a C).

Table 2 shows diseases the workflow is designed to interrogate, and the corresponding genes and nucleotides targeted.

TABLE 2

| | | | NT |
|---|---|---|---|
| DISEASE | OMIM ID | GENE | TARGETED |
| Familial hyperinsulinism | 256450 | ABCC8 | 5,808 |
| Canavan disease | 271900 | ASPA | 1,062 |
| Maple syrup urine | 248600 | BCKDHA | 1,518 |
| disease type 1a/1b | | BCKDHB | 1,379 |
| Bloom syndrome | 210900 | BLM | 4,674 |
| Cystic fibrosis | 219700 | CFTR | 5,444 |
| Usher syndrome type IIIA | 276902 | CLRN1 | 856 |
| Dihydrolipoamide | 248600 | DLD | 1,810 |
| dehydrogenase deficiency | | | |
| Fanconi anemia group C | 227645 | FANCC | 1,957 |
| Glycogen storage | 232200 | G6PC | 1,174 |
| disease type 1a | | | |
| Tay-Sachs disease | 272800 | HEXA | 1,870 |
| Familial dysautonomia | 223900 | IKBKAP | 4,719 |
| Mucolipidosis type IV | 252650 | MCOLN1 | 2,023 |
| Usher syndrome type IF | 602083 | PCDH15 | 6,508 |
| Niemann-Pick | 257200/607616 | SMPD1 | 2,056 |
| disease type A/B | | | |
| | | TOTAL | 42,858 |

Table 3 shows pathogenic mutations detected in cell line-derived samples. Entries shown in single curly {braces} were determined a priori to be inaccessible by NGS and therefore not evaluated here. Entries in double curly {{braces}} represent mutations in affected individuals that were previously unknown. Entries shown in triple curly {{{braces}}} represent mutations that were present in Hapmap samples previously un-annotated with respect to carrier status.

TABLE 3

| | | Mut1 Common | Mut1 | Mut2 Common | Mut2 |
|---|---|---|---|---|---|
| Sample | Gene | Name | Found? | Name | Found? |
| GM04268 | ASPA | E285A | Yes | E285A | Yes |
| GM00649 | BCKDHA | Y438N | Yes | 8bp del exon 7 | Yes |
| GM00650 | BCKDHA | Y438N | Yes | — | — |
| GM01531 | CFTR | PHE508DEL | Yes | PHE508DEL | Yes |
| GM02828 | CFTR | V520F | Yes | PHE508DEL | Yes |
| GM04330 | CFTR | 1812−1G>A | Yes | 444delA | Yes |
| GM06966 | CFTR | E92X | Yes | PHE508DEL | Yes |
| GM07381 | CFTR | IVS19DS, +10 KB, C>T | Yes | PHE508DEL | Yes |
| | | (3849+10kbC>T) | | | |
| GM07441 | CFTR | 621+1G>T | Yes | IVS16, G>A, +1 | Yes |
| | | | | (3120+1G>A) | |
| GM07552 | CFTR | ARG553TER | Yes | PHE508DEL | Yes |
| GM07732 | CFTR | E60X | Yes | PHE508DEL | Yes |
| GM07857 | CFTR | M1101K | Yes | M1101K | Yes |
| GM08338 | CFTR | GLY551ASP | Yes | — | — |
| GM11275 | CFTR | 1-BP DEL, 3659C | Yes | PHE508DEL | Yes |
| GM11277 | CFTR | ILE507DEL | Yes | ILE507DEL | Yes |
| GM11278 | CFTR | Q493X | Yes | PHE508DEL | Yes |
| GM11280 | CFTR | 621+1G>T | Yes | 711+1G>T | Yes |
| GM11281 | CFTR | 621+1G>T | Yes | PHE508DEL | Yes |
| GM11282 | CFTR | 621+1G>T | Yes | GLY85GLU | Yes |
| GM11283 | CFTR | {ALA455GLU} | N/A | PHE508DEL | Yes |
| GM11284 | CFTR | ARG560THR | Yes | PHE508DEL | Yes |
| GM11285 | CFTR | Y1092X | Yes | PHE508DEL | Yes |
| GM11287 | CFTR | P574H | Yes | PHE508DEL | Yes |
| GM11288 | CFTR | G178R | Yes | PHE508DEL | Yes |
| GM11370 | CFTR | 444delA | Yes | IVS11−1G>A | Yes |
| GM11472 | CFTR | ASN1303LYS | Yes | GLY1349ASP | Yes |
| GM11496 | CFTR | GLY542TER | Yes | GLY542TER | Yes |
| GM11497 | CFTR | GLY542TER | Yes | — | — |
| GM11723 | CFTR | TRP1282TER | Yes | — | — |
| GM11859 | CFTR | 2789+5G>A | Yes | 2789+5G>A | Yes |
| GM11860 | CFTR | IVS19DS, +10 KB, C>T | Yes | IVS19DS, +10 KB, | Yes |
| | | (3849+10kbC>T) | | C>T | |
| | | | | (3849+10kbC>T) | |
| GM12444 | CFTR | IVS10AS, G>A, −1 | Yes | — | — |
| | | (1717−1G>A) | | | |
| GM12585 | CFTR | ARG1162TER | Yes | — | — |
| GM12785 | CFTR | ARG347PRO | Yes | GLY551ASP | Yes |
| GM12960 | CFTR | ARG334TRP | Yes | {{c.3368−2A>T}} | Yes |
| GM13423 | CFTR | G85E | Yes | D1152H | Yes |
| GM13591 | CFTR | ARG117HIS | Yes | PHE508DEL | Yes |
| GM18668 | CFTR | {CFTRdele2,3} | N/A | PHE508DEL | Yes |
| GM18799 | CFTR | 2184delA | Yes | PHE508DEL | Yes |
| GM18800 | CFTR | 1898+1 G>A | Yes | PHE508DEL | Yes |
| GM18802 | CFTR | Y122X | Yes | {{R1158X}} | Yes |
| GM18886 | CFTR | 2143delT | Yes | PHE508DEL | Yes |
| GM20737 | CFTR | R347H | Yes | — | — |
| GM20741 | CFTR | 3876delA | Yes | — | — |
| GM20745 | CFTR | S549N | Yes | — | — |
| GM20924 | CFTR | R75X | Yes | — | — |
| GM21080 | CFTR | 394delTT | Yes | — | — |
| GM11468 | G6PC | R83C | Yes | Q347X | Yes |
| GM00502 | HEXA | 1278insTATC | Yes | 1421+1G>C | Yes |
| GM03461 | HEXA | 1421+1G>C | Yes | G269S | Yes |
| GM05042 | IKBKAP | 2507+6T>C | Yes | 2507+6T>C | Yes |
| GM02533 | MCOLN1 | IVS3−2A>G | Yes | {del ex1-ex7} | N/A |
| GM03252 | SMPD1 | L302P | Yes | — | — |
| GM13205 | SMPD1 | fsP330 | Yes | — | — |
| GM16193 | SMPD1 | R496L | Yes | Arg608DEL | Yes |
| GM19116 | CFTR | {{{ARG334TRP}}} | Yes | — | — |
| GM17363 | IKBKAP | {{{2507+6T>C}}} | Yes | — | — |
| GM17366 | IKBKAP | {{{2507+6T>C}}} | Yes | — | — |
| GM17365 | IKBKAP | {{{2507+6T>C}}} | Yes | — | — |
| GM17364 | IKBKAP | {{{2507+6T>C}}} | Yes | — | — |
| GM17360 | MCOLN1 | {{{IVS3−2A>G}}} | Yes | — | — |
| GM17362 | HEXA | {{{1278insTATC}}} | Yes | — | — |
| GM18015 | HEXA | {{{c.739C>T}}} | Yes | — | — |
| GM17362 | HEXA | {{{G269S}}} | Yes | — | — |

### Genotyping by Assembly-Templated Alignment (GATA)

Although substitutions comprise the majority of coding variation in the human genome, insertions and deletions (indels) are often clinically relevant. Indels, especially when large or present in cis with substitutions, are notoriously difficult to detect with short NGS reads. Assembly of short reads can improve indel detection sensitivity, but this is often at the cost of decreased SNV and indel specificity due to the presence of spurious contiguous sequence (contigs). A method—termed Genotyping by Assembly-Templated Alignment (GATA)—was devised that first forms an assembly from reads partitioned into subsets by targeting arm sequence, then performs base quality- and coverage-informed genotyping by alignment of raw reads back to the assembled contigs (FIG. 10).

The performance of GATA for indel genotyping was compared to the more conventional genotyping-by-alignment only (AO) method used for the Sanger SNV concordance studies. Across a set of 147 samples re-sequenced for this analysis, both indel sensitivity and specificity were increased with GATA relative to AO (Table 4). GATA detected 23 unique insertions and deletions, which were confirmed by manual review of Sanger traces. Of these 9 (39%) were not detected by AO in one or more samples, including BLM c.2207_{—}2212delinsTAGATTC—the most common disease-causing mutation for Bloom syndrome in people of Ashkenazi Jewish descent—as well as several alleles in SMPD1, the gene associated with Niemann-Pick disease. Performance for substitutions was identical for both detection methods.

Table 4 shows genotyping by assembly-templated alignment (GATA) improves detection of insertions and deletions. Raw variant alleles (positive calls) from 147 samples were filtered by depth and strand bias and categorized according to NGS data analysis method, alignment only (AO) or GATA. Calls were classified with GATA considered truth as true positive (TP), false positive (FP), and false negative (FN). Discordant calls, in all cases, were confirmed by manual review of corresponding Sanger traces and found to be GATA TP or TN, rather than FP or FN. Variant calls flagged as low-confidence are considered uncalled. *Polymorphisms in the first exon of SMPD1 accounted for the majority of uncalled and discordant alleles, which were not considered in accuracy calculations.

TABLE 4

| | AO | GATA |
|---|---|---|
| TP | 104 | 211 |
| FP | 28 | 0 |
| FN | 47 | 0 |
| Uncalled* | 70 | 10 |
| Sensitivity | 0.696 | 1.0 |
| Precision | 0.786 | 1.0 |

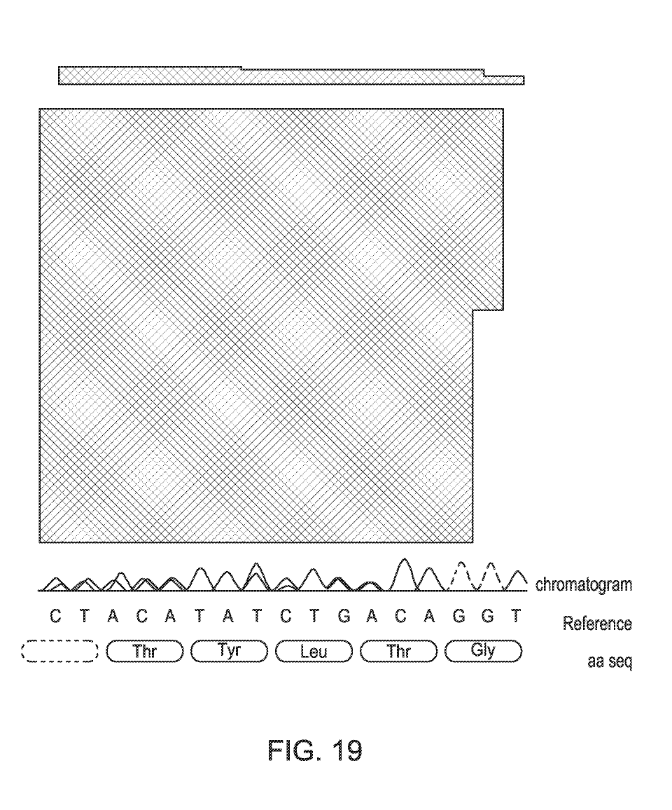

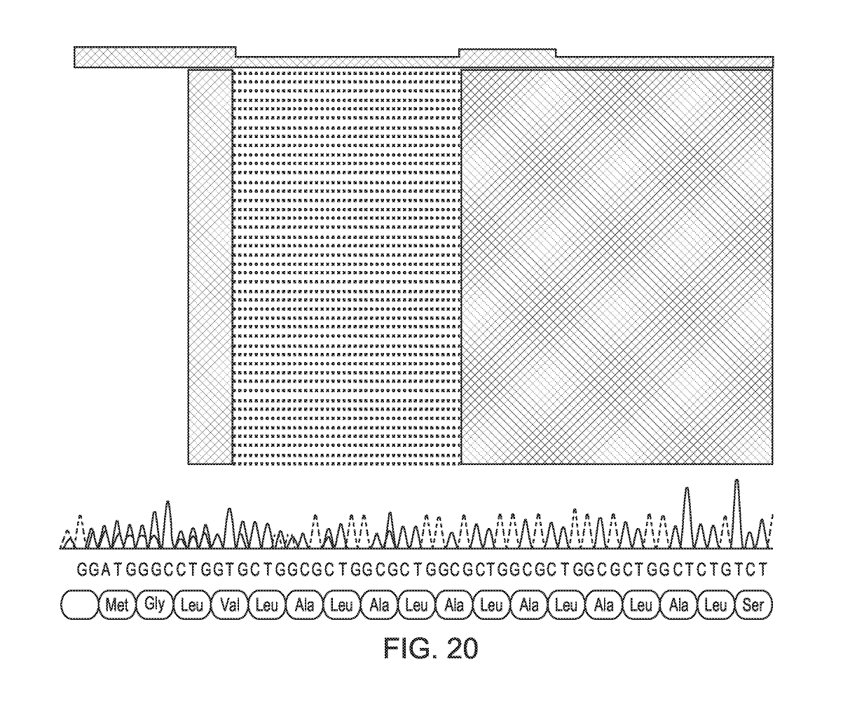

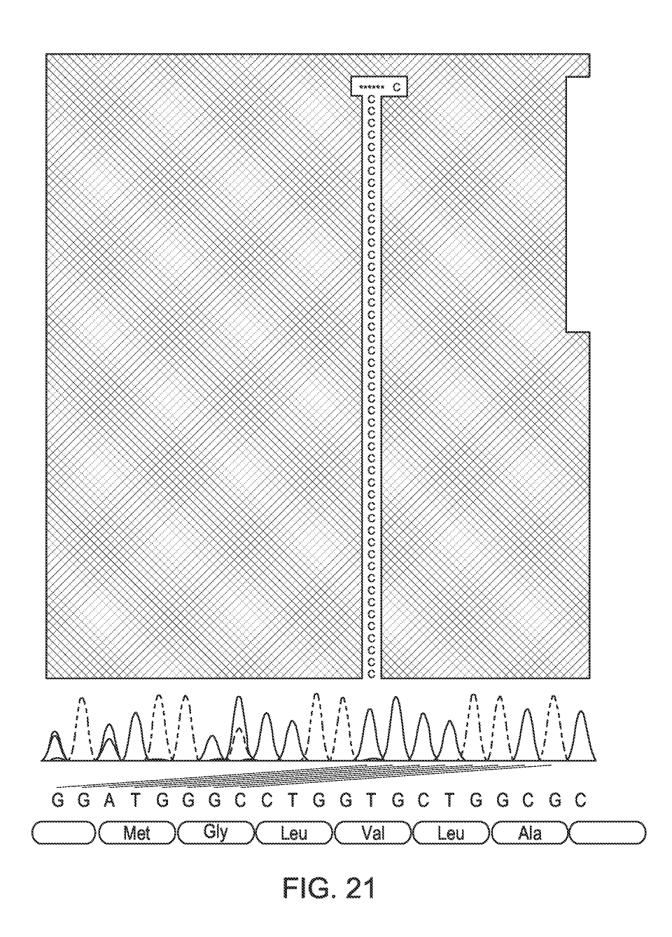

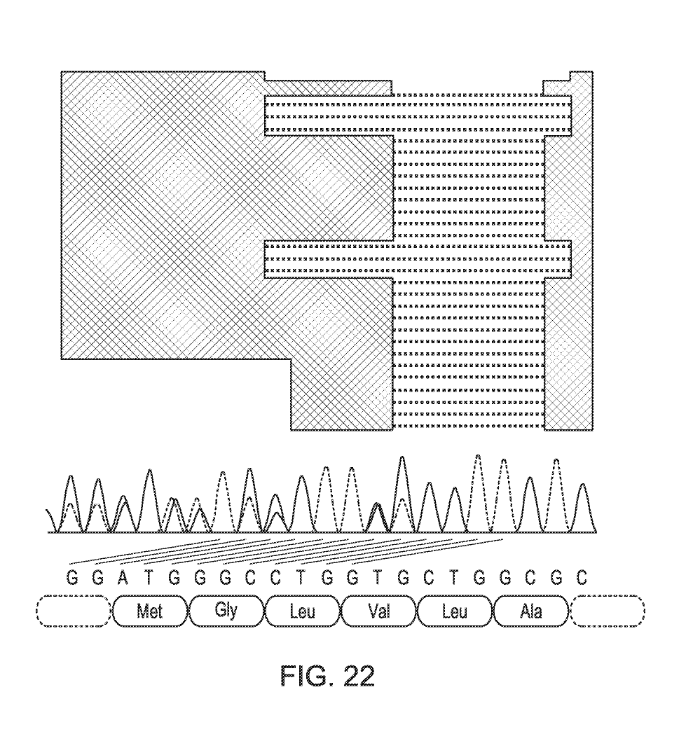

As seen in FIGS. 19-22, GATA correctly genotypes insertions and deletions that are undetectable by prior art methods such as methods that operate by alignment only. FIG. 19, FIG. 20, FIG. 21, and FIG. 22 each provides, read from top to bottom, tracks for cumulative depth of coverage (vertical grey bars); representative molecular inversion probe alignments (horizontal grey bars) with mismatches (letters), and gaps (dashed lines); chromatogram; reference DNA and amino acid sequence. In the depicted IGV views, aligned bases that do not match the reference are color coded, and insertions (I) and deletions (−) relative to the reference are visible. Aligned bases that match the reference are gray. FIGS. 19-22 show several alleles in the first exon of SMPD1.

FIG. 19 represents heterozygous BLM c.2207_{—}2212delinsTAGATTC in sample GM04408. In FIG. 19, the depicted portion of the reference is:

| | |
|---|---|
| CTACATATCTGACAGGT. | (SEQ ID NO: 11) |

In FIG. 19, the depicted amino acid sequence is:

| | |
|---|---|
| Thr Tyr Leu Thr Gly | (SEQ ID NO: 12) |

FIG. 20 represents a heterozygous 18 bp deletion in sample GM20342 (minus strand). In FIG. 20, the depicted portion of the reference is:

GGATGGGCCTGGTGCTGGCGCTGGCGCTGGCGCTGGCGCTGGCGCTGGCTCT GTCT (SEQ ID NO: 13). In FIG. 20, the depicted amino acid sequence is:

(SEQ ID NO: 14)
Met Gly Leu Val Leu Ala Leu Ala Leu Ala Leu Ala Leu Ala Leu Ala Leu Ser

FIG. 21 depicts a heterozygous 12 bp insertion and homozygous substitution in sample GM17282 (plus strand). In FIG. 21, the depicted portion of the reference is:

GGATGGGCCTGGTGCTGGCGC (SEQ ID NO: 15). In FIG. 21, the depicted amino acid sequence is:

| | |
|---|---|
| Met Gly Leu Val Leu Ala | (SEQ ID NO: 16) |

FIG. 22 shows compound heterozygous 6 and 12 bp deletions in sample GM00502 (minus strand). In FIG. 22, the depicted portion of the reference is GGATGGGCCTGGTGCTGGCGC (SEQ ID NO: 15). In FIG. 22, the depicted amino acid sequence is Met Gly Leu Val Leu Ala (SEQ ID NO: 16) Chromatogram trace offsets corresponding to specific heterozygous insertion and deletion patterns are indicated with slanted lines. For clarity offsets are shown for FIG. 21 and FIG. 22 only.

### Simulation to Assess Detectability of Rare Pathogenic Mutations

While detectability was demonstrated for all disease-causing mutations present in the sample set, there exist a number of disease-causing mutations for which samples cannot be readily obtained. To assess whether NGS workflow can detect these mutations, simulations were performed in silico. Since detectability can be affected by any element of the workflow, a simulator was implemented that employed read sets from actual samples rather than model reads derived from the reference genome at uniform coverage. This allowed for realistic representation of target abundance distribution, neighboring in cis variants, as well as cycle- and context-dependent sequencing errors. Disease-causing variants were introduced into raw reads by a Bernoulli process, with an average 0.5 probability of introducing the lesion, to simulate the heterozygous genotypes carrier screening aims to detect.

A total of 81 heterozygous variants were simulated in a read set of at least 144 samples with the exception of c.1521_{—}1523delCTT (F508del), the most common disease-causing mutation for cystic fibrosis in Caucasian populations (Table 5). This mutation was present in several samples, which were removed from simulation analysis (Methods). Of the simulated variants 67 (83%) were correctly genotyped in all (generally 145/145) samples and only four relatively large (>7 bp) deletions were undetected in one or more samples. High-confidence genotype calls were not made for the remaining 10 variants. No variants were found to be undetectable in all samples. Table 5 gives the performance results of GATA for detecting clinically-relevant mutations by simulation.

TABLE 5

| | Samples | Variant | Variant | Variant |
|---|---|---|---|---|
| Variant | Simulated | Positive | Uncalled | Negative |
| BLM c.2207_2212delinsTAGATTC | 146 | 146 | 0 | 0 |
| CFTR c.1923_1931delCTCAAAACTinsA | 147 | 147 | 0 | 0 |
| CFTR c.1973_1985del13insAGAAA | 146 | 146 | 0 | 0 |
| CFTR | 147 | 147 | 0 | 0 |
| c.723_743 + 1delGAGAATGATGATGAAGTACA | | | | |
| GG (SEQ ID NO: 17) | | | | |
| CFTR c.3067_3072delATAGTG | 147 | 147 | 0 | 0 |
| CFTR_c.650_659delAGTTGTTACA | 145 | 145 | 0 | 0 |
| (SEQ ID NO: 18) | | | | |
| CFTR_c.1871_1878delGCTATTTT | 145 | 145 | 0 | 0 |
| CFTR_c.739_742dupTACA | 145 | 145 | 0 | 0 |
| CFTR_c.578_579 + 5delAAGTATG | 145 | 145 | 0 | 0 |
| CFTR_c.3421_3424dupAGTA | 145 | 145 | 0 | 0 |
| BLM_c.991_995del5 | 145 | 145 | 0 | 0 |
| CFTR_c.2589_2599delAATTTGGTGCT | 145 | 46 | 7 | 92 |
| (SEQ ID NO: 19) | | | | |
| CFTR_c.3664_3665insTCAA | 145 | 145 | 0 | 0 |
| CFTR_c.2634_2641delGGTTGTGC | 145 | 143 | 1 | 1 |
| CFTR_c.156_163dupATTGGAAA | 145 | 145 | 0 | 0 |
| CFTR_c.522_526delAATAA | 145 | 145 | 0 | 0 |
| ABCC8_c.259_268del10 | 145 | 141 | 3 | 1 |
| CFTR_c.1616_1617dupTA | 145 | 145 | 0 | 0 |
| CFTR_c.3068_3072delTAGTG | 145 | 145 | 0 | 0 |
| FANCC_c.356_360del5 | 145 | 145 | 0 | 0 |
| CFTR_c.861_865delCTTAA | 145 | 145 | 0 | 0 |
| ABCC8_c.2835_2838delGAGA | 145 | 145 | 0 | 0 |
| CFTR_c.319_326delGCTTCCTA | 145 | 145 | 0 | 0 |
| CFTR_c.2249_2256del8 | 145 | 145 | 0 | 0 |
| CFTR_c.1792_1798delAAAACTA | 145 | 145 | 0 | 0 |
| CFTR_c.2241_2248delGATACTGC | 145 | 145 | 0 | 0 |
| G6PC_c.462_466delTTTGT | 145 | 145 | 0 | 0 |
| CFTR_c.35_36insTATCA | 145 | 145 | 0 | 0 |
| HEXA_c.1471_1475delTCTGA | 145 | 145 | 0 | 0 |
| PCDH15_c.996_999delGGAT | 145 | 145 | 0 | 0 |
| ASPA_c.568_574del7 | 145 | 144 | 0 | 1 |
| CFTR_c.3184_3188dupCTATG | 145 | 145 | 0 | 0 |
| SMPD1_c.1657_1663delACCGCCT | 145 | 145 | 0 | 0 |
| CFTR_c.1162_1168delACGACTA | 145 | 145 | 0 | 0 |
| BCKDHB_c.163_166dupACTT | 145 | 145 | 0 | 0 |
| BCKDHA_c.861_868delAGGCCCCG | 145 | 145 | 0 | 0 |
| CFTR_c.3773dupT | 145 | 145 | 0 | 0 |
| CFTR_c.1155_1156dupTA | 145 | 145 | 0 | 0 |
| CFTR_c.3889dupT | 145 | 145 | 0 | 0 |
| HEXA_c.1274_1277dupTATC | 145 | 145 | 0 | 0 |
| CFTR_c.262_263delTT | 144 | 144 | 0 | 0 |
| CFTR_c.326_327delAT | 145 | 145 | 0 | 0 |
| CFTR_c.3691delT | 145 | 145 | 0 | 0 |
| CFTR_c.3528delC | 144 | 144 | 0 | 0 |
| BLM_c.2407dupT | 145 | 145 | 0 | 0 |
| CFTR_c.1521_1523delCTT | 131 | 131 | 0 | 0 |
| HEXA_c.915_917delCTT | 145 | 145 | 0 | 0 |
| G6PC_c.379_380dupTA | 145 | 145 | 0 | 0 |
| CFTR_c.2012delT | 144 | 144 | 0 | 0 |
| SMPD1_c.1829_1831delGCC | 144 | 144 | 0 | 0 |
| CFTR_c.1029delC | 145 | 127 | 18 | 0 |
| CFTR_c.2737_2738insG | 145 | 145 | 0 | 0 |
| CFTR_c.2947_2948delTT | 145 | 142 | 3 | 0 |
| CFTR_c.1911delG | 145 | 145 | 0 | 0 |
| CFTR_c.803delA | 145 | 145 | 0 | 0 |
| CFTR_c.1519_1521delATC | 145 | 145 | 0 | 0 |
| CFTR_c.805_806delAT | 145 | 18 | 127 | 0 |
| CFTR_c.2215delG | 145 | 137 | 8 | 0 |
| FANCC_c.67delG | 145 | 145 | 0 | 0 |
| CFTR_c.935_937delTCT | 145 | 145 | 0 | 0 |
| CFTR_c.2175dupA | 145 | 145 | 0 | 0 |
| CFTR_c.3530delA | 145 | 145 | 0 | 0 |
| CFTR_c.531delT | 145 | 145 | 0 | 0 |
| CFTR_c.1021_1022dupTC | 145 | 127 | 18 | 0 |
| CFTR_c.3659delC | 145 | 145 | 0 | 0 |
| DLD_c.104dupA | 144 | 144 | 0 | 0 |
| CFTR_c.2052dupA | 144 | 144 | 0 | 0 |
| CFTR_c.313delA | 145 | 145 | 0 | 0 |
| G6PC_c.79delC | 145 | 145 | 0 | 0 |
| CFTR_c.442delA | 145 | 145 | 0 | 0 |
| CFTR_c.1477_1478delCA | 145 | 145 | 0 | 0 |
| CFTR_c.1545_1546delTA | 145 | 145 | 0 | 0 |
| BCKDHA_c.117delC | 145 | 145 | 0 | 0 |
| CFTR_c.1418delG | 145 | 145 | 0 | 0 |
| CFTR_c.1976delA | 145 | 145 | 0 | 0 |
| CFTR_c.3536_3539delCCAA | 145 | 145 | 0 | 0 |
| CFTR_c.948delT | 145 | 145 | 0 | 0 |
| CFTR_c.2052delA | 145 | 145 | 0 | 0 |
| BCKDHB_c.595_596delAG | 145 | 145 | 0 | 0 |
| G6PC_c.980_982delTCT | 145 | 145 | 0 | 0 |
| CFTR_c.3039delC | 145 | 145 | 0 | 0 |

### Discussion

Robustness, completeness, and accuracy are three of the main factors that define the utility of a genetic carrier testing workflow in a clinical laboratory. By utilizing a target enrichment methodology that is performed in a single tube, inexpensive, and requires no shearing or purifications, an automated NGS workflow was developed that yields highly-reproducible results across samples and operators. This reproducibility ensures that samples will not have to be rerun frequently, minimizing both turnaround time and per-sample cost.

Because each clinically meaningful base pair must be sequenced before an actionable medical report can be generated, a high level of completeness minimizes the amount of costly re-work necessary for a sample. Completeness consistent with low to no re-work for the samples studied here was demonstrated, and better than other previously-reported methods using multiplex target capture or PCR with NGS. This improvement is likely the result of a number of improvements here made relative to previous reports including the use of a tiling MIP design that ensures multiple probes capture each base and the use of a DNA extraction protocol that shears the DNA to a lower molecular mass.

Regarding accuracy, the only SNV false negative observed was in a sample that exhibited skewed allele ratios along the chromosome, which should not commonly occur when testing for germline mutations in clinical specimens derived from whole blood. Additionally, the SNV false positive rate of approximately 1.5 per million base pairs corresponds to a low confirmation burden for clinical testing and surpasses values previously reported. Given the small target set and the rare nature of indels, it is difficult to give a precise measurement of the accuracy for indels in general, though the data do suggest that the use of GATA improves ability to detect small lesions. Additionally, there is an observed sensitivity of 100% by both AO and GATA across the set of disease-causing insertions and deletions in carrier and affected samples.

It is worth noting that measuring accuracy to a sufficient level of precision and generality can be challenging within conserved coding regions because selective pressure limits the spectrum of variation present. While a large number of samples were sequenced, the relatively small size of the target limited the number of unique alleles observable and meant that approximately 90% of such variants were common (i.e. present in dbSNP). Nonetheless, there is no a priori reason to believe that the measured accuracy will not generalize to other rare and private mutations present in the targeted loci. Supporting this point, simulations using real data and controlled for sample-to-sample variability indicate that a number of very rare disease causing alleles of different types and sequence contexts can be detected, including insertions (up to 12 bp), deletions (up to 22 bp) and complex combinations thereof (so called ‘delins’).

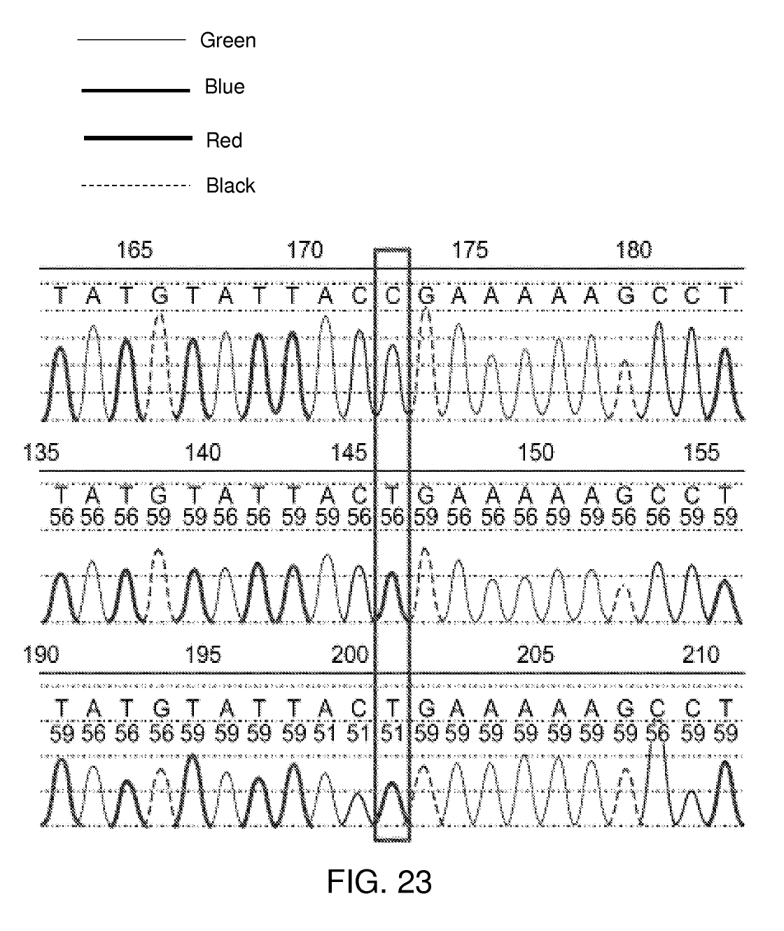

The reference standard one considers ground truth can impose a ceiling on measurable accuracy. Automated analysis of what is widely deemed the ‘gold standard’ for DNA sequencing was employed: bi-directional Sanger traces derived from PCR amplicons. FIGS. 23-28 show NGS detects allele dropout in Sanger sequencing reactions. FIGS. 23-25 shows dropout of reference allele leads to homozygous non-reference call by Sanger sequencing, but heterozygous non-reference call by NGS, in BLM exon 12 of GM18034.

FIG. 23 shows dropout of reference allele leads to homozygous non-reference call by Sanger sequencing with unmodified primer pair in BLM exon 12. FIG. 23 shows, for the original PCR primer pair, from top to bottom: expected reference sequence trace, sample forward trace, sample reverse trace. In FIG. 23, the expected reference sequence trace is TATGTATTACCGAAAAAGCCT (SEQ ID NO: 20). The sample forward and reverse traces are each TATGTATTACTGAAAAAGCCT (SEQ ID NO: 21).

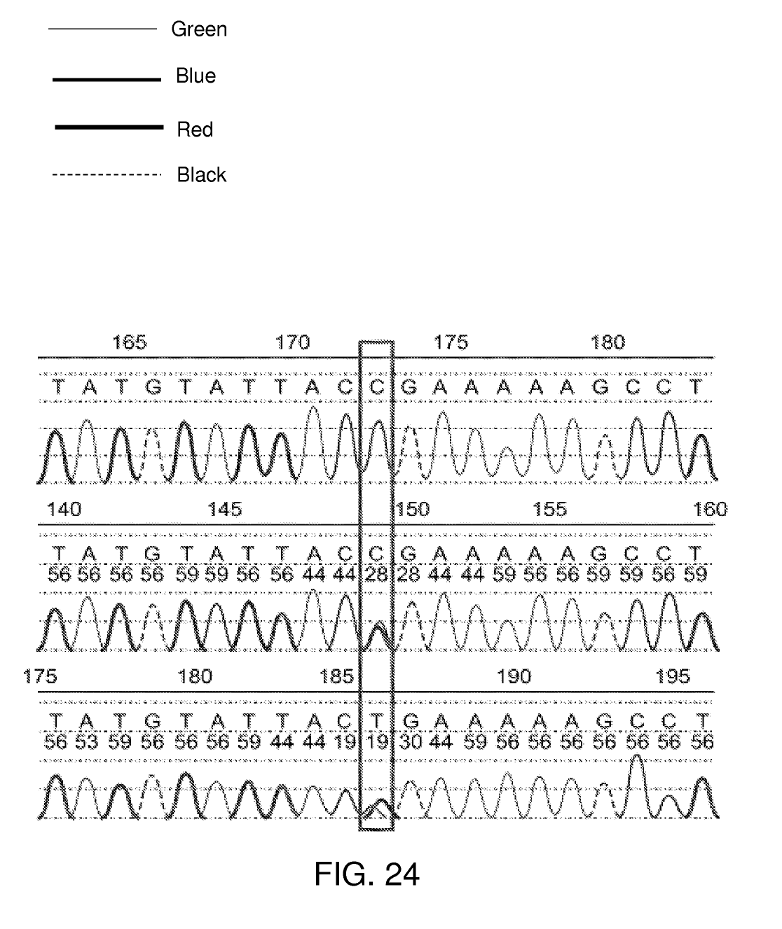

FIG. 24 shows Sanger results using a re-designed primer pair in BLM exon 12. FIG. 24 shows for the re-designed PCR primer pair, from top to bottom: expected reference sequence trace, sample forward trace, sample reverse trace. In FIG. 24, the expected reference sequence trace is TATGTATTACCGAAAAAGCCT (SEQ ID NO: 20). The sample forward and reverse traces are each TATGTATTACCGAAAAAGCCT (SEQ ID NO: 20).

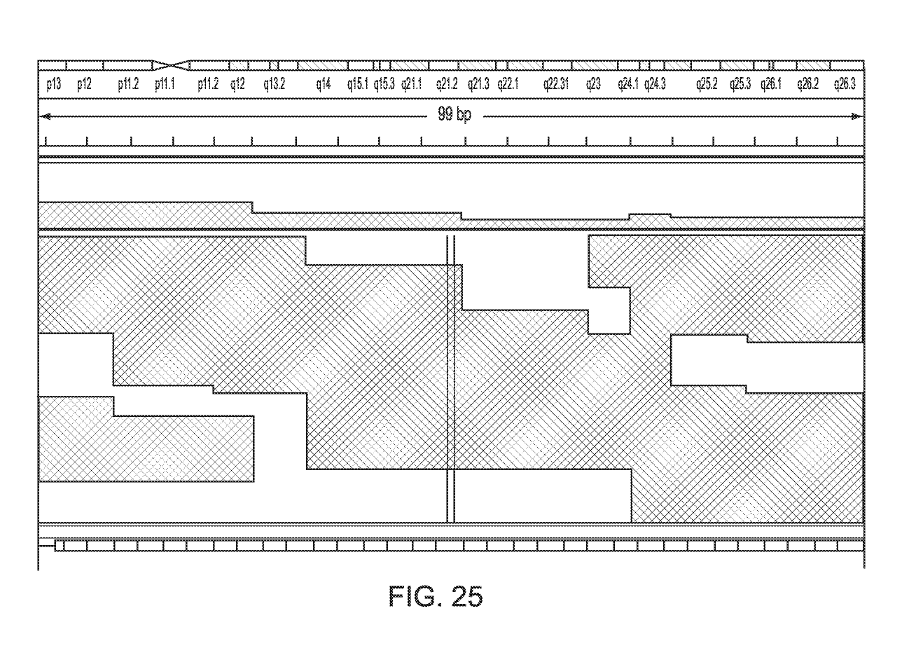

FIG. 25 shows the IGV of NGS data. FIG. 25 reveals a heterozygous non-reference call by IGV of NGS data in BLM exon 12. In FIG. 25, the depicted portion of the reference is: AGGTTTAGCATGAGCTTTAACAGACATAATCTGAAATACTATGTATTACCGAAAAAG CCTAAAAAGGTGGCATTTGATTGCCTAGAATGGATCAGAAAG (SEQ ID NO: 22)

In FIG. 25, the depicted amino acid sequence is: Phe Ser Met Ser Phe Asn Arg His Asn Leu Lys Tyr Tyr Val Leu Pro Lys Lys Pro Lys Lys Val Ala Phe Asp Cys Leu Glu Trp Ile Arg Lys (SEQ ID NO: 23)

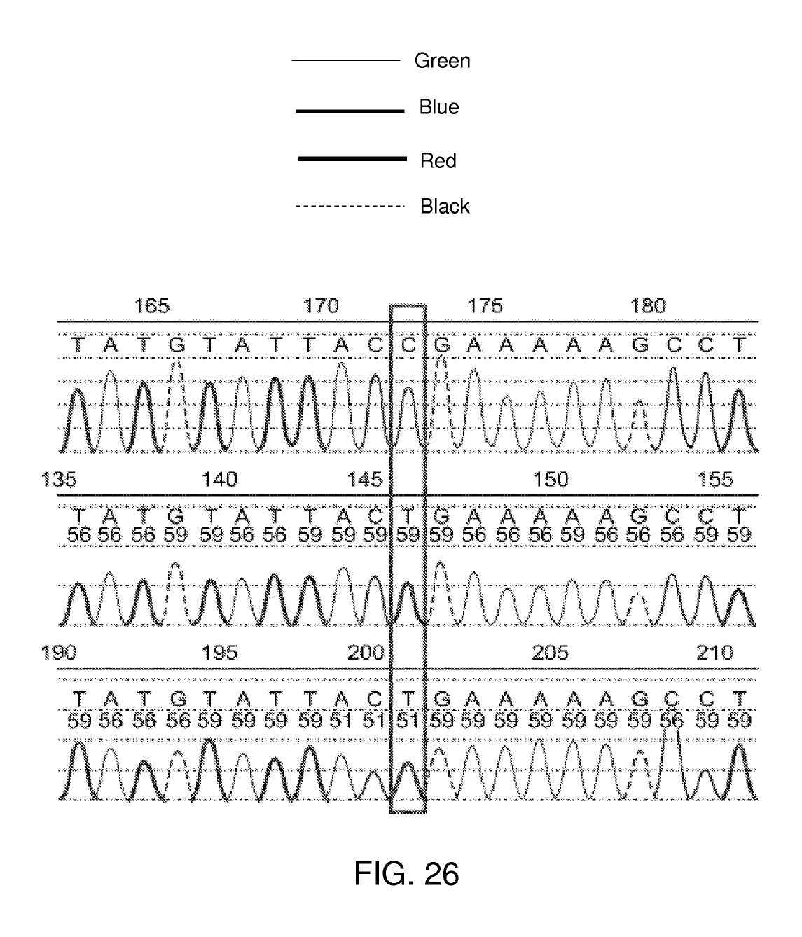

FIGS. 26-28 show dropout of non-reference allele leads to homozygous reference call by Sanger sequencing, but heterozygous non-reference call by NGS, in DLD exon 9 of sample GM11370.

FIG. 26 shows homozygous reference call using an unmodified primer pair and Sanger sequencing for a dropout in DLD exon 9. FIG. 26 shows, for the original PCR primer pair, from top to bottom: expected reference sequence trace, sample forward trace, sample reverse trace. In FIG. 26, the expected reference sequence trace is TATGTATTACCGAAAAAGCCT (SEQ ID NO: 20). The sample forward and reverse traces are each TATGTATTACTGAAAAAGCCT (SEQ ID NO: 21).

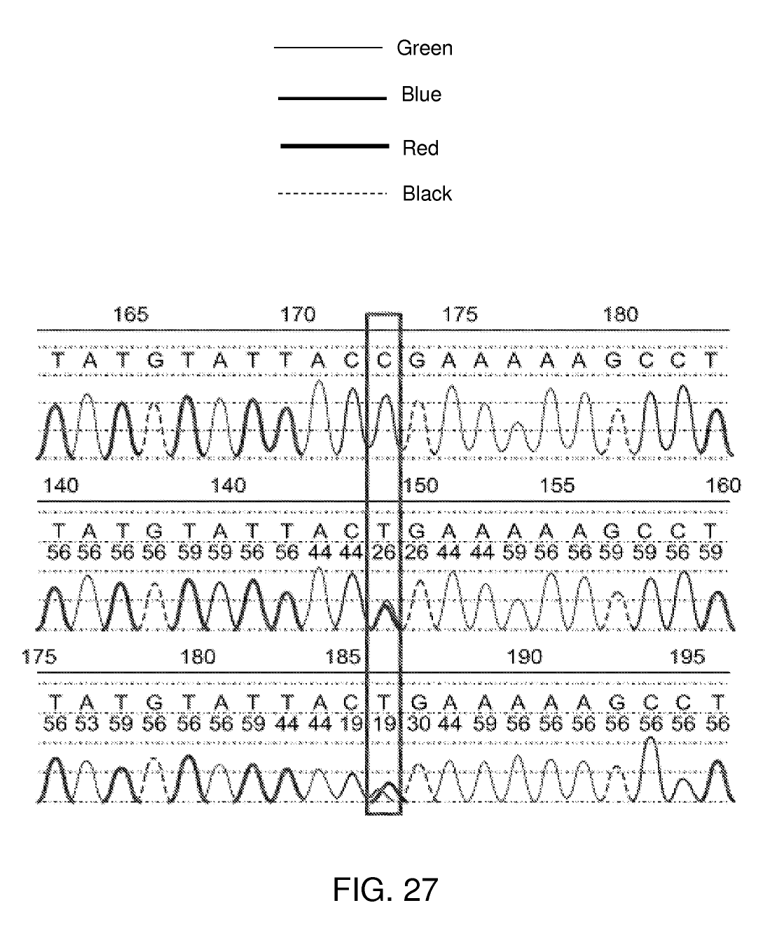

FIG. 27 shows Sanger results for a re-designed primers for the dropout in DLD exon 9. FIG. 27 shows, for the re-designed PCR primer pair, from top to bottom: expected reference sequence trace, sample forward trace, sample reverse trace. In FIG. 27, the expected reference sequence trace, the sample forward trace, and the sample reverse trace are each TATGTATTACCGAAAAAGCCT (SEQ ID NO: 20).

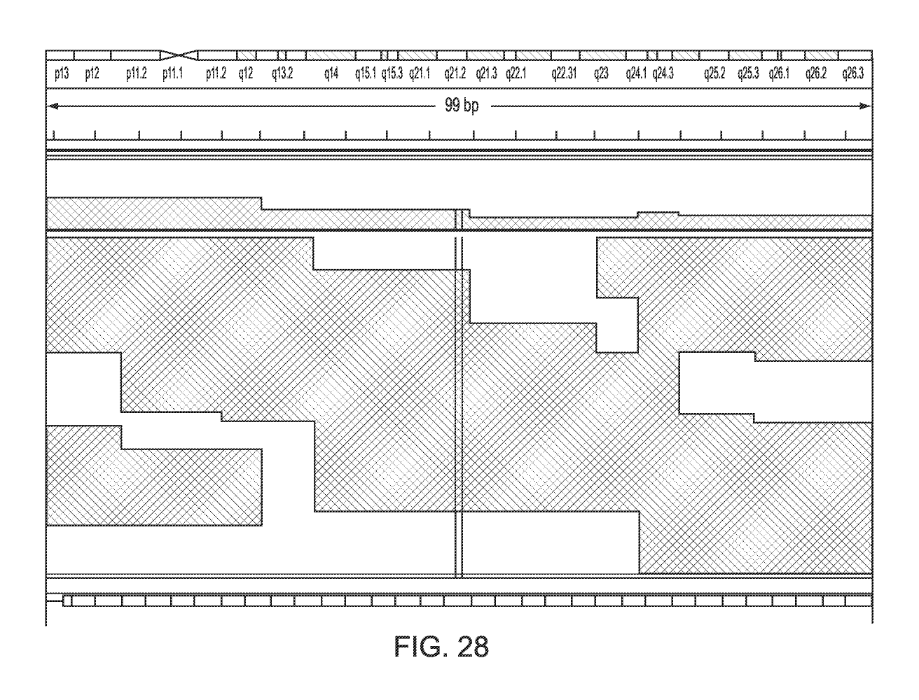

FIG. 28 gives the IGV of NGS data. FIG. 28 shows heterozygous reference call NGS data for the dropout in DLD exon 9. In FIG. 28, the depicted portion of the reference is AGGTTTAGCA TGAGCTTTAA CAGACATAAT CTGAAATACT ATGTATTACC GAAAAAGCCT AAAAAGGTGG CATTTGATTG CCTAGAATGG ATCAGAAAG (SEQ ID NO: 22). In FIG. 28, the depicted amino acid sequence is Phe Ser Met Ser Phe Asn Arg His Asn Leu Lys Tyr Tyr Val Leu Pro Lys Lys Pro Lys Lys Val Ala Phe Asp Cys Leu Glu Trp Ile Arg Lys (SEQ ID NO: 23).

The NGS workflow detected allele dropout in the Sanger data, a known limitation of that technology and not surprising since each base sequenced by NGS was captured by multiple probes with independent targeting arms. Had the less laborious and more commonly-used reference of Hapmap Project genotyping data been employed, 12 NGS false negatives and 7 false positives would have been observed in the subset of samples characterized by this approach (Table 6). This would have underestimated both sensitivity and specificity.

Table 6 shows concordance of NGS genotypes with HapMap data. All NGS positions called with high confidence (minimum 50× coverage and strand bias<=0) that intersected Hapmap release 27 phase II+III genotyping data were evaluated, for a total of 5,337 genotypes across 83 samples. True negative: reference called by both NGS and HapMap; true positive: non-reference (heterozygous or homozygous) called by both NGS and HapMap; false positive: non-reference called by NGS, reference called by HapMap; false negative: reference called by NGS, non-reference called by HapMap. Specificity: TN/(TN+FP); sensitivity: TP/(TP+FN).

TABLE 6

| | |
|---|---|
| True negatives | 4,233 |
| True positives | 538 + 547 = 1,085 |
| False positives | 7 |
| False negatives | 12 |
| Specificity | 0.998 |
| Sensitivity | 0.989 |

Indel detection methods that only employ gapped alignment of short reads to reference may be limited by false positives introduced by systematic, context-dependent sequencing error, and false negatives introduced by failure of the aligner to open or extend gaps. An assembly-based paradigm may address these limitations but raw contigs do not always carry base quality and coverage information. GATA combines these approaches to deliver sensitive and specific indel detection with SNV performance on par with a traditional alignment only pipeline.

Many alleles detected exclusively by GATA were from a short tandem repeat (STR) region encoding the N-terminal signal peptide in SMPD1. Consistent with previous reports, GATA detected non-reference alleles in 96% of samples, a rate that is strikingly high because hg18 contains a minor allele that is frequently substituted (V36A). While common hexanucleotide indels at this locus may be clinically benign, any pathogenic mutation present in cis may be missed using a conventional approach for variant detection. Indeed, when reads were aligned independently, several genomic positions in this region consistently fell below the specified coverage threshold. GATA therefore should yield higher sensitivity for rare mutations linked to polymorphisms in the first exon of SPMD1 and potentially other STR loci as well.

The simulation methodology applied here attempts to assess detectability of rare pathogenic mutations in a highly realistic manner. Simply deriving reads from a reference genome modified to include the mutation of interest can overestimate the detection probability because of real-world factors that would otherwise render the mutation undetectable. Additionally, it can be determined whether a mutation is sometimes, rather than always or never, detectable because it is simulated in the read sets of hundreds of samples; e.g., this could occur in a particular genetic background with a low-frequency in cis variant that interferes with alignment of reads containing the mutation.

An automated, integrated workflow that converts human genomic DNA isolated from blood or cell lines into clinically-relevant variant calls is presented. High genotype concordance with conventional electrophoretic sequencing across a set of 15 genes is achieved, and the ability to detect a range of important disease-causing mutations is demonstrated. The new analysis pipeline allows for sensitive and specific detection of indels while simultaneously incorporating raw base quality and coverage into SNV genotype calls. Realistic simulation on actual run data indicates that a number of pathogenic mutations undetectable by a traditional alignment-based genotyping approach are accessible by GATA. Collectively, the data indicate that the workflow has met three of the major requirements of a clinical carrier screening assay, supporting the notion that NGS is ready for clinical use.

What is claimed is:

1. A method of evaluating a genetic test, the method comprising:
obtaining, using a computer comprising a non-transitory memory, a plurality of sequence reads;
introducing, using the computer, a simulated mutation into at least one of the plurality of sequence reads;
analyzing the sequence reads using a genetic pipeline;
determining if the genetic pipeline identified the simulated mutation, thereby validating the genetic pipeline.

2. The method of claim 1, further comprising introducing the simulation into about half of the plurality of sequence reads.

3. The method of claim 1, wherein introducing the simulated mutation comprises manipulating a data field for base sequence or quality.

4. The method of claim 1, wherein the simulated mutation comprises two mutations in cis.

5. The method of claim 1, further comprising assembling the sequence reads prior to introducing the simulated mutation.

6. The method of claim 1, wherein the analyzing step comprises assembling the plurality of sequence reads to produce a contig.

7. The method of claim 6, wherein the analyzing step further comprises aligning the contig to a reference.

8. The method of claim 7, wherein the analyzing step further comprises aligning one or more of the plurality of sequence reads to the contig.

9. The method of claim 1, further comprising using the computer to automatically introduce a number of different simulated mutations into different ones of the plurality of sequence reads.

10. The method of claim 1, wherein the genetic pipeline comprises instructions in the memory operable to cause the computer to assemble the plurality of sequence reads.

11. The method of claim 10, wherein the computer is operable to detect a mutation and report the mutation in relation to a reference.
